(19) United States
(12) Patent Application Publication
(10) Pub. No.: US 2018/0063642 A1
(43) Pub. Date: Mar. 1, 2018

(54) ELECTRONIC DEVICE

(71) Applicant: LG ELECTRONICS INC., Seoul (KR)

(72) Inventors: Seungjong PARK, Seoul (KR); Youchang KIM, Seoul (KR); Teahoon YOU, Seoul (KR); Dongyun HYUN, Seoul (KR)

(73) Assignee: LG ELECTRONICS INC., Seoul (KR)

(21) Appl. No.: 15/685,847

(22) Filed: Aug. 24, 2017

(30) Foreign Application Priority Data
Aug. 24, 2016 (KR) 10-2016-0107917

(51) Int. Cl. H04R 5/033; H04R 1/10

(52) U.S. Cl. CPC H04R 5/0335; H04R 1/1066

(57) ABSTRACT

An electronic device includes a body and a first support coupled to one portion of the body, where the first support extends from the body along a line in a first direction relative to a central axis of the body. The device further includes a second support coupled another portion of the body, where the second support extends from the body along a line in a second direction relative to a central axis of the body, and an ear loop connecting the first support to the second support. The shape of the ear loop permits coupling with a user's ear, such that the shape of the ear loop changes according to changes in a degree of an angle between the line in the first direction and the line in the second direction.

### CROSS-REFERENCE TO RELATED APPLICATIONS

Pursuant to 35 U.S.C. §119(a), this application claims the benefit of earlier filing date and right of priority to Korean Application No. 10-2016-0107917, filed on Aug. 24, 2016, the contents of which are all hereby incorporated by reference herein in its entirety.

### BACKGROUND

### 1. Field

The present disclosure relates to an electronic device formed in an overall shape according to rotation angles of multiple supports fastened to a body thereof so as to be tightly attached to a user's ears.

### 2. Description of Related Art

Electronic devices may be classified as a mobile/portable terminal and a stationary terminal according to whether or not they are movable. Mobile terminals may be also classified as a handheld terminal and a vehicle mounted terminal according to whether or not it can be directly carried by a user.

Functions of mobile terminals have become diversified. Mobile terminals have functions of performing data transmission and voice communication, capturing images or video through a camera, recording voice, playing music files through a speaker system, and outputting an image or video to a display unit. Some of mobile terminals additionally support an electronic game play function or a multiplayer function. In particular, recent mobile terminals are available to receive multicast signals providing visual content such as broadcast, video, television programs. With diversified functions, such terminals are implemented as multimedia players having complex functions such as capturing images or video, reproducing music or video files, playing games, receiving broadcast signals, and the like. In order to support and increase such functions of terminals, improvements of structural parts and/or software parts of terminals may be considered. Recently, research into wearable type electronic devices which can be worn on a user's body has been conducted.

### SUMMARY

According to an aspect of the present disclosure, an electronic device includes: a body; and a wearing part including a first support fastened to one side of the body, a second support fastened to the other side of the body, and an ear loop connected to the first support and the second support and bent at least once along the user's cartilage, wherein the ear loop of the wearing part is changed in shape by adjusting an angle between the first support and the second support on the basis of the body.

The wearing part may be tilted to be tightly attached to an inner side of the user's cartilage.

The ear loop may include: an ear-seated part extending from the other end of the first support and bent to surround an inner side at an upper end of the user's cartilage; and an ear support extending from the ear-seated part and bent to support an inner side at a lower end of the user's cartilage.

The ear-seated part may be convexly bent in a direction away from the body and the ear support may be concavely bent in a direction toward the body.

An ear housing which can be inserted into the user's ear may be fastened to an inner surface of the body.

The ear housing may be fastened to the inner surface of the body such that the ear housing deviates from a central point of the body.

The ear housing may include: a first housing; a second housing whose upper end is fastened to a lower end of the first housing and a lower end is fastened to the inner surface of the body; a nozzle protruding from one side of an upper end of the first housing; and a speaker disposed within the first and second fastened housings, wherein the second housing may form an echo space in an internal space between the speaker and the inner surface of the body.

The body may include a tilting unit fastened to one end of the first support inserted into an upper end of a circumferential surface of the body, and the tilting unit may include: a damper-seated part corresponding to a region in which the first support is rotated and having ridges and valleys repeated along the inside of the first body; a damper member disposed to be in contact with the damper-seated part, deformed in shape when brought into contact with the ridges, and returned to the original shape thereof when brought into contact with the valleys; and a damper controller having one end fastened to the first body and the other end is fastened to the damper member and rotating in the same direction as that of the first support.

The body may include a tilting unit fastened to one end of the first support inserted into an upper end of a circumferential surface of the body, and the tilting unit may include: a damper-seated part corresponding to a region in which the first support is rotated and having ridges and valleys repeated along the inside of the first body; and a damper member disposed to be in contact with the damper-seated part and contracted in length when brought into contact with the ridges and returned to the original length thereof when brought into contact with the valleys.

A waterproof member may be provided between the first support and the body.

The body may include a molding member disposed between the first support and the second support and allowing a cable to be drawn out therethrough, and a drawn-out angle of the cable drawn out through the molding member may range from 25° to 35° with respect to a vertical direction.

The ear housing may include a patterned part disposed to surround a central region of the ear housing.

The electronic device of the present disclosure has the following advantages.

According to at least one of the embodiments of the present disclosure, since an overall shape of the electronic device is deformed according to rotational angles of multiple supports fastened to the body and easily tightly attached to the user's ears, adherence may be enhanced.

According to at least one of the embodiments of the present disclosure, since the body and the ear housing are easily fastened to each other or separated from each other by the fastening member, components disposed within the electronic device may be easily repaired or exchanged. Thus, time required for after-sales service may be shortened and cost may be reduced.

According to at least one of the embodiments of the present disclosure, since a portion of the ear housing in contact with the user's skin is patterned, an area in contact with the user's skin may be reduced, enhancing wearing sensation.

According to at least one of the embodiments of the present disclosure, since the wearing part is bent at least once, when the electronic device is worn on, the rear of a lower end of the user's cartilage, while surrounding an upper end of the user's cartilage, may be supported, enhancing fitting sensation.

According to at least one of the embodiments of the present disclosure, since the rear of a lower end of the user's cartilage is supported, while surrounding an upper end of the user's cartilage, the electronic device worn on the user's ears may be prevented from being arbitrarily released or moved.

According to at least one of the embodiments of the present disclosure, since the waterproof member is disposed between the body and the wearing part, penetration of moisture or a foreign material from an external environment may be prevented in advance, further improving splash resistance.

According to at least one of the embodiments of the present disclosure, since the damper structure using elasticity is provided between the body and multiple supports, a tilt use sensation of the supports fastened to the body and making a rotational operation may be enhanced.

According to at least one of the embodiments of the present disclosure, since an echo space is formed in a rear space of the speaker disposed in the ear housing, sound quality may be enhanced.

According to at least one of the embodiments of the present disclosure, since the circuit board is disposed in any one of the first and second bodies and the battery is disposed in the other, the battery having larger capacity may be disposed to lengthen a use time of the electronic device.

Still further embodiments include an electronic device having a body and a first support coupled to one portion of the body, where the first support extends from the body along a line in a first direction relative to a central axis of the body. The device further includes a second support coupled to another portion of the body, where the second support extends from the body along a line in a second direction relative to a central axis of the body, and an ear loop connecting the first support to the second support. The shape of the ear loop permits coupling with a user's ear, such that the shape of the ear loop changes according to changes in a degree of an angle between the line in the first direction and the line in the second direction.

An additional scope of applicability of the present invention will be understood from the detailed description. It is to be understood that both the foregoing general description and the following detailed description of the preferred embodiments of the present invention are exemplary and explanatory and are intended to provide further explanation of the invention as claimed.

### BRIEF DESCRIPTION OF DRAWINGS

The above and other aspects, features, and advantages of the present disclosure will be more clearly understood from the following detailed description taken in conjunction with the accompanying drawings.

FIG. 1 is a perspective view of an electronic device according to an embodiment of the present disclosure.

FIG. 2 is a perspective view of a first body among bodies according to an embodiment of the present disclosure.

FIG. 3A is an exploded view of FIG. 2.

FIG. 3B is an exploded view of a component of FIG. 3A.

FIG. 4 is a perspective view of a second body among bodies according to an embodiment of the present disclosure.

FIG. 5A is an exploded view of FIG. 4.

FIG. 5B is an exploded view of a component of FIG. 5A.

FIG. 6 is a plan view of a wearing part according to an embodiment of the present disclosure.

FIG. 7 is a perspective view of a wearing part according to an embodiment of the present disclosure.

FIG. 8 is a perspective view of an ear housing according to an embodiment of the present disclosure.

FIG. 9 is an exploded view of FIG. 8.

FIGS. 10 and 11 are views illustrating an electronic device operating according to an embodiment of the present disclosure.

FIG. 12 is a view illustrating a user wearing an electronic device.

FIG. 13 is a view illustrating an operation in which one side of a first support is fastened to a first body and tilted according to an embodiment of the present disclosure.

FIG. 14 is a perspective view of a damper member disposed in the first body according to an embodiment of the present disclosure.

FIG. 15 is a view illustrating an operation in which one side of a first support is fastened to a first body and tilted according to another embodiment of the present disclosure.

FIG. 16 is a view illustrating a waterproof member according to an embodiment of the present disclosure.

FIG. 17 is a view illustrating a thickness and a width of a first wearing part according to an embodiment of the present disclosure.

FIGS. 18A, 18B, 18C are views illustrating a thickness of an ear loop of a first support and a second support according to an embodiment of the present disclosure.

FIG. 19 is a view illustrating a position of a first ear housing fastened to a first body according to an embodiment of the present disclosure.

FIG. 20 is a view illustrating a first ear housing patterned according to an embodiment of the present disclosure.

FIGS. 21A, 21B are views illustrating a first ear housing fastened to a user's ear according to an embodiment of the present disclosure.

FIG. 22 is a view illustrating an echo space of a first ear housing according to an embodiment of the present disclosure.

FIG. 23 is a view illustrating a region in which a first ear housing is sealed according to an embodiment of the present disclosure.

FIG. 24 is a view illustrating a region in which a second ear housing is sealed according to an embodiment of the present disclosure.

FIG. 25 is a view illustrating a lower surface of a first ear housing according to an embodiment of the present disclosure.

FIGS. 26A, 26B are views illustrating a remote controller button part in an electronic device according to an embodiment of the present disclosure.

FIG. 27 is a view illustrating an electronic device according to another embodiment of the present disclosure.

FIG. 28 is a view illustrating an electronic device according to another embodiment of the present disclosure.

FIGS. 29A, 29B, and 30-33 are views illustrating operations of an electronic device according to another embodiment of the present disclosure.

### DETAILED DESCRIPTION

Hereinafter, an embodiment of the present invention will be described in detail with reference to the attached drawings. A detailed description of the present invention to be described hereinafter together with the attached drawings describes an embodiment of the present invention and does not represent a sole embodiment in which the present invention may be executed. The following detailed description includes detailed contents in order to provide complete understanding of the present invention. However, a person of ordinary skill in the art knows that the present invention may be executed without such detailed contents.

Reference will now be made in detail embodiments of the invention examples of which are illustrated in the accompanying drawings. Since the present invention may be modified in various ways and may have various forms, specific embodiments are illustrated in the drawings and are described in detail in the present specification. However, it should be understood that the present invention are not limited to specific disclosed embodiments, but include all modifications, equivalents and substitutes included within the spirit and technical scope of the present invention.

The terms ‘first’, ‘second’, etc. may be used to describe various components, but the components are not limited by such terms. The terms are used only for the purpose of distinguishing one component from other components. For example, a first component may be designated as a second component without departing from the scope of the present invention. In the same manner, the second component may be designated as the first component.

The term “and/or” encompasses both combinations of the plurality of related items disclosed and any item from among the plurality of related items disclosed.

When an arbitrary component is described as “being connected to” or “being linked to” another component, this should be understood to mean that still another component(s) may exist between them, although the arbitrary component may be directly connected to, or linked to, the second component. In contrast, when an arbitrary component is described as “being directly connected to” or “being directly linked to” another component, this should be understood to mean that no component exists between them.

The terms used in the present application are used to describe only specific embodiments or examples, and are not intended to limit the present invention. A singular expression can include a plural expression as long as it does not have an apparently different meaning in context.

In the present application, the terms “include” and “have” should be understood to be intended to designate that illustrated features, numbers, steps, operations, components, parts or combinations thereof exist and not to preclude the existence of one or more different features, numbers, steps, operations, components, parts or combinations thereof, or the possibility of the addition thereof.

Unless otherwise specified, all of the terms which are used herein, including the technical or scientific terms, have the same meanings as those that are generally understood by a person having ordinary knowledge in the art to which the present invention pertains. The terms defined in a generally used dictionary must be understood to have meanings identical to those used in the context of a related art, and are not to be construed to have ideal or excessively formal meanings unless they are obviously specified in the present application.

The following embodiments of the present invention are provided to those skilled in the art in order to describe the present invention more completely. Accordingly, shapes and sizes of elements shown in the drawings may be exaggerated for clarity.

An electronic device according to an embodiment of the present disclosure may include a cellular phone, a smartphone, a laptop computer, a terminal for digital broadcast, a personal digital assistant (PDA), a portable multimedia player (PMP), a navigation, a slate PC, a tablet PC, an ultrabook, and a wearable device. The wearable device may include a smartwatch, a smart glass, or a head-mounted display (HMD), and the like.

By way of non-limiting example only, further description will be made with reference to particular types of electronic devices. However, such teachings apply equally to other types of terminals, such as those types noted above. In addition, these teachings may also be applied to stationary terminals such as digital TV, desktop computers and a digital signage.

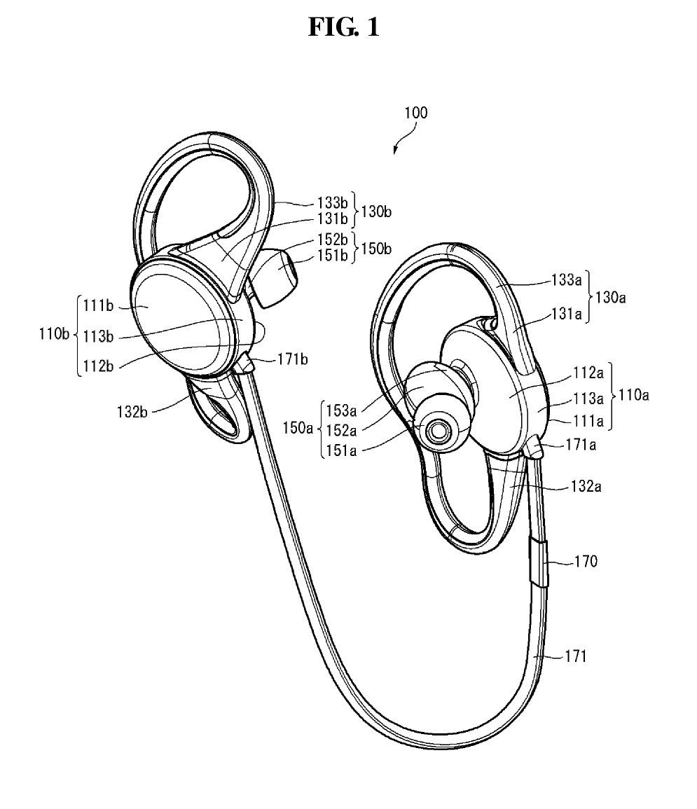

Referring to FIG. 1, an electronic device 100 according to an embodiment of the present disclosure may include bodies 110a and 110b, wearing parts 130a and 130b, and ear housings 150a and 150b.

In the bodies 110a and 110b, outer surfaces 11a and 111b and inner surfaces 112a and 112b may be spaced apart from each other by a predetermined interval and have a predetermined thickness. In the bodies 110a and 110b, circumferential surfaces 113a and 113b may be disposed along edges of the outer surfaces 111a and 111b and edges of the inner surfaces 112a and 112b and have a predetermined height. A cross-section taken along between the outer surfaces 111a and 111b and the inner surfaces 112a and 112b of the bodies 110a and 110b may have a polygonal or circular shape. The bodies 110a and 110b may have a hollow shape. Although not shown, a circuit terminal, a battery, and the like, may be disposed within the bodies 110a and 110b.

In the bodies 110a and 110b, at least one button, an input/output port, and the like, may be disposed on any one of the outer surfaces 111a and 111, the inner surfaces 112a and 112b, and the circumferential surfaces 113a and 113b. The button and the input/output port may be electrically connected to the circuit terminal or the battery.

The bodies 110a and 110b may include a first body 110a and a second body 110b. The first body 110a may be worn on the user's left ear. The second body 110b may be worn on the user's right ear.

The first body 110a and the second body 110b may be electrically connected by a cable 171. One end of the cable 171 may be inserted into a first molding member 171a of the first body 110a so as to be connected, and the other end may be inserted into a second molding member 171b of the second body 110b so as to be connected.

In the cable 171, a remote controller button part 170 capable of controlling the first body 110a or the second body 110b may be disposed between the first body 110a and the second body 110b.

The wearing parts 130a and 130b may include first supports 131a and 131b, second supports 132a and 132b, and ear loops 133a and 133b, respectively. The first supports 131a and 131b may be fastened to one side of the bodies 110a and 110b, respectively. The second supports 132a and 132b may be spaced apart from the first supports 131a and 131b at a predetermined interval and fastened to the other sides of the bodies 110a and 110b, respectively. The first supports 131a and 131b and the second supports 132a and 132b may be disposed on the circumferential surfaces 113a and 113b of the bodies 110a and 110b, respectively.

The ear loops 133a and 133b are disposed between the first supports 131a and 131b and the second supports 132a and 132b, respectively, and one side thereof may be connected to the first supports 131a and 131b and the other sides thereof may be connected to the second supports 132a and 132b, respectively. The ear loops 133a and 133b may be bent one or more times.

In the wearing parts 130a and 130b, while the first supports 131a and 131b and the second supports 132a and 132b rotate on the basis of the bodies 110a and 110b, angles between the first supports 131a and 131b and the second supports 132a and 132b may be controlled within a predetermined range.

The ear housings 150a and 150b may be disposed in portions of the inner surfaces 112a and 112b of the bodies 110a and 110b, respectively. The ear housings 150a and 150b may protrude from the inner surfaces 112a and 112b of the bodies 110a and 110b by a predetermined height so as to be inserted into the user's ears.

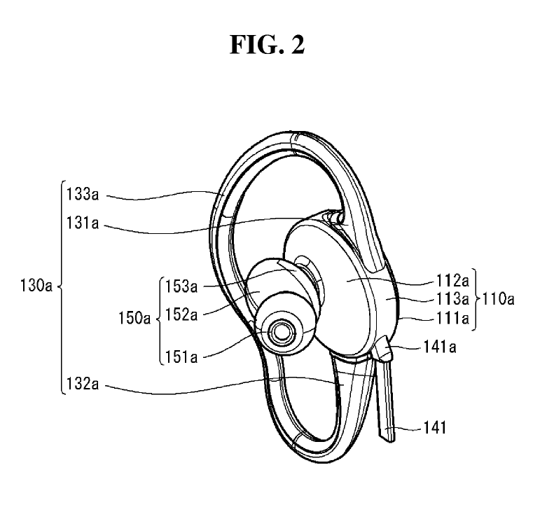

Referring to FIGS. 2 to 5, the first body 110a according to an embodiment of the present disclosure may include a wireless communication unit 115a, an interface unit 116a, a memory 117a, a controller 118a, and the like. All of the components illustrated in FIGS. 2 to 5 are not essential and the electronic device 100 described in this disclosure may have fewer or greater components.

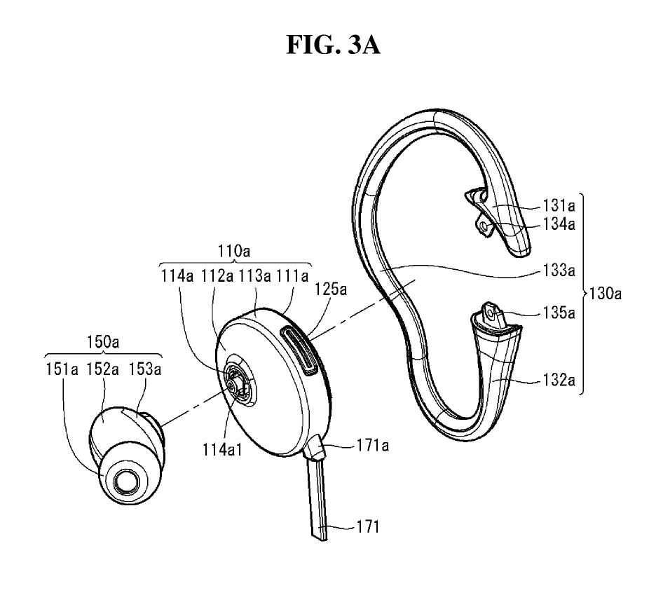

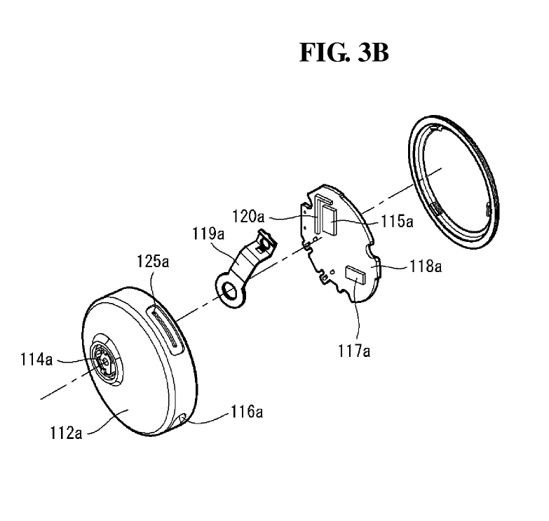

Referring to FIGS. 2, 3A, and 3B, the first body 110a may include the wireless communication unit 115a, the interface unit 116a, the memory 117a, the controller 118a, and a tilting unit 119a.

In the first body 110a, a housing recess 114a fastened to the first ear housing 150a may be disposed on an inner surface. In the housing recess 114a, at least one anti-rotation member 114a1 may be disposed in and protrude from the housing recess 114a. The anti-rotation member 114a1 may prevent arbitrary rotation of the first ear housing while the first ear housing 150a is fastened to the housing recess 114a. The anti-rotation member 114a1 may guide the first ear housing 150a to be fastened to the housing recess 114a in an accurate direction.

Also, a first wearing hole 134a extending toward the first body 110a may be disposed on one end surface of the first support 131a of the first wearing part 130a, and a second wearing hole 135a extending toward the first body 110a may be disposed on one end surface of the second support 132a of the first wearing part 130a. The first wearing hole 134a and the second wearing hole 135a may be inserted into the first body 110a and fastened by a fastening member 160.

The wireless communication unit 115a may be disposed within the first body 110a of the electronic device 110. The wireless communication unit 115a may include one or more modules enabling wireless communication between the electronic device 100 and a wireless communication system, between the electronic device 100 and another electronic device 100, or between the electronic device 100 and an external server. The wireless communication unit 115a may include one or more modules connecting the electronic device 100 to one or more networks. The wireless communication unit 115a may include at least one of a broadcast mobile communication module, a wireless Internet module, a short-range communication module, and a position information module.

The interface unit 116a may be disposed on any one of the outer surface 111a, the inner surface 112a, and the circumferential surface 113a of the first body 110a. The interface unit 116a may serve as an interface with various types of external devices that can be connected to the electronic device 100. The interface unit 116a may include any of an external charger port, a wired or wireless data port, a memory card port, a port for connecting a device having an identification module, and an audio input/output (I/O) port. The electronic device 100 according to an embodiment of the present disclosure may perform appropriate controlling related to a connected external device in response to the external device connected to the interface unit 116a. For example, the external charger port may be substantially the same as a charge terminal port of a mobile terminal and the electronic device 100 may be charged through the external charger port, video I/O ports, earphone ports, and the like. In some cases, the mobile terminal 100 may perform assorted control functions associated with a connected external device, in response to the external device being connected to the interface unit 160.

The memory 117a stores data supporting various functions of the electronic device 100. The memory 117a may store multiple application programs (or applications) driven in the electronic device 100 and data and commands for operations of the electronic device.

The user may download some of a plurality of programs from an external server using wireless communication and store the downloaded programs in the memory 117a. The application programs may be stored in the memory 117a and may be driven to perform an operation (or function) of the electronic device 100 under the control of the controller 118a. The plurality of application programs may include a basic program for operating a basic operation of the electronic device 100. The basic program may be stored in the electronic device 100 at the time when it was released from a factory.

The controller 118a may control a general operation of the electronic device 100 in addition to an operation related to an application program. The controller 118a may process a signal, data, information, and the like, input/output through the interface unit 116a or may drive an application program stored in the memory 117a. The controller 118a may drive an application program by combining and operating at least two or more components included in the electronic device 100.

The controller 118a may be disposed as any one of various types of printed circuit board (PCB) and flexible printed circuit board (FPCB). The controller 118a may be implemented by semiconductor packaging, a technology of packaging a chip to apply the chip to a device.

Also, the first body 110a may include an antenna 120a. The antenna 120a may be an antenna for the wireless communication unit 115a. The antenna 120a may be flexible. When the body 110a includes the antenna 120a, the wireless communication unit 115a is expected to have enhanced transmission/reception capability.

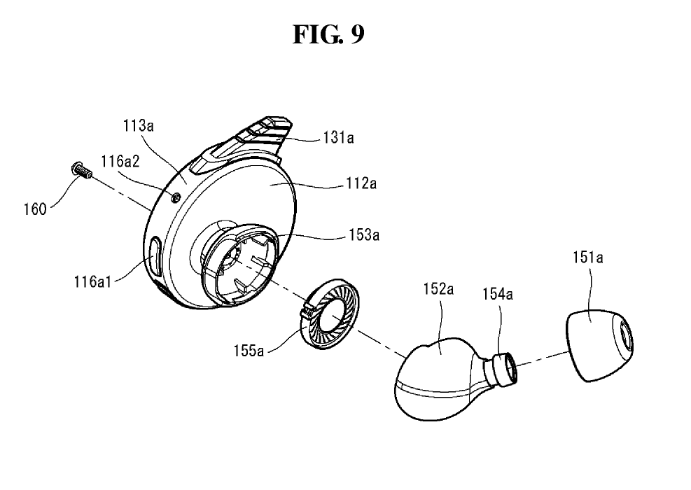

The tilting unit 119a may be fastened to the first support 131a of the first wearing part 130a. The tilting unit 119a may be fastened to one end of the first support 131a inserted into an upper end of the circumferential surfaces 113a and 113b of the bodies 110a and 110b to control the first support 131a to a predetermined tilting angle. The tilting unit 119a may be fastened to one end of the first support 131a through the fastening member 160 (FIG. 9). The tilting unit 119a may control a tilting angle between the first support 131a and the second support 132a. That is, the tilting angle may include a first tilting angle and a second tilting angle.

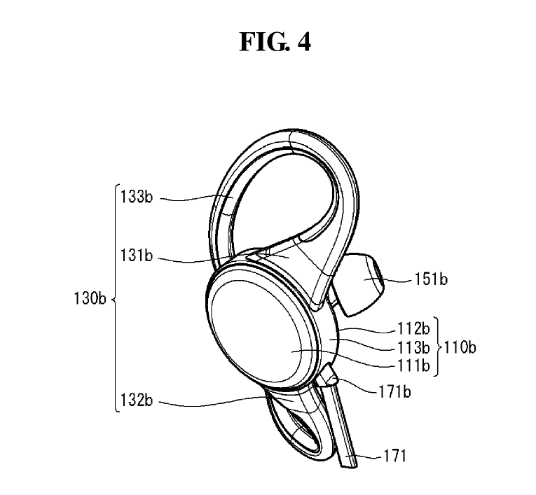

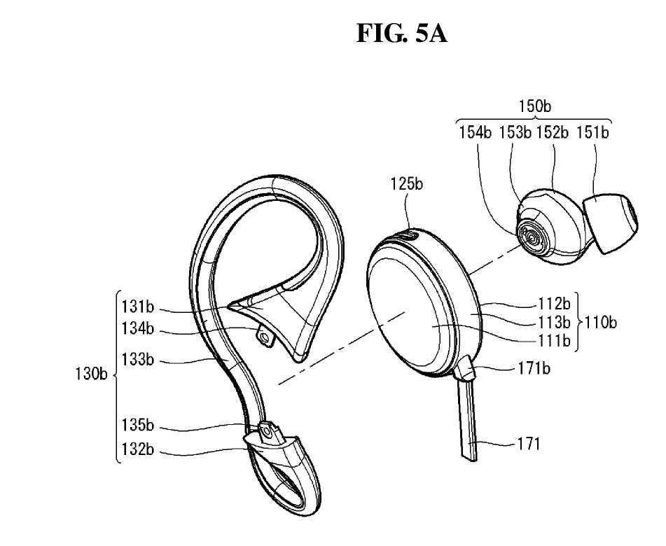

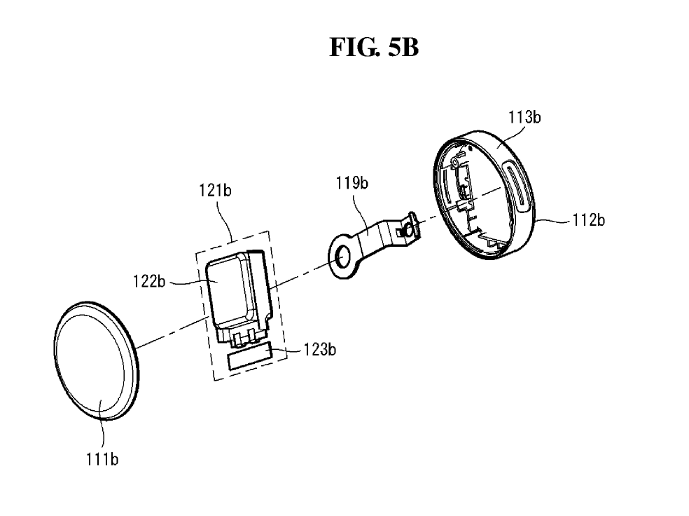

Referring to FIGS. 4, 5A, and 5B, the second body 110b may include a power supply unit 121b and a tilting unit 119b.

In the second wearing part 130b, a first wearing hole 134b extending toward the second body 110b may be disposed on one end surface of the first support 131b, and a second wearing hole 135b extending toward the second body 110b may be disposed on one end surface of the second support 132b. The first wearing hole 134b and the second wearing hole 135b may be inserted into the second body 110b and fastened by the fastening member 160 (FIG. 9).

The power supply unit 121b may be disposed within the second body 110b. The second body 110b may be electrically connected to the first body 110a through the cable 171.

The cable 171 may include at least one line such as a signal line, a power line, and the like.

The power supply unit 121b disposed in the second body 110b may be provided with external power using a charge port disposed in the first body 110a and a power line electrically connected to the first body 110a and store the provided external power. The power supply unit 121b may supply the stored external power to the controller 118a, the wireless communication unit 115a, and the like, disposed in the first body 110a using the power line. That is, the power supply unit 121b may receive power from the outside, store the received power, and supply the stored power to each component included in the electronic device 100 under the control of the controller 118a.

The power supply unit 121b may include a battery 122b capable of storing power. The battery 122b may be an internal battery or a replaceable battery.

The power supply unit 121b may include a power conversion unit 123b converting external power supplied from the outside to internal power. The power conversion unit 123b may be disposed in the first body 110b and convert external power into internal power which can be stably supplied to each component. Since the power supply unit 121b includes the power conversion unit 123b, damage to a component or malfunction of a component due to an overvoltage or an abnormal voltage supplied from the outside may be prevented in advance.

As described above, in the electronic device 100 according to an embodiment of the present disclosure, components may be separately disposed in the first body 110a and the second body 110b. For example, the power supply unit 121b and components closely related to the power supply unit 121b may be disposed in the second body 110b. The other components excluding the power supply unit 121b may be disposed in the first body 110a. In this manner, since multiple components and the power supply unit 121b are separately disposed in the first body 110a and the second body 110b, respectively, in the electronic device 100, internal space of the second body 110b may be easily secured. Thus, the power supply unit 121b may include a battery 122b. Since the battery 122b having capacity as large as the secured internal space is installed in the second body 110b, power may be supplied to the electronic device 100 for a longer period of time. Thus, the user may use the electronic device for a longer period of time.

The tilting unit 119b may be fastened to the first support 131b of the second wearing part 130b. The tilting unit 119b is substantially the same as the tilting unit 119a described above, and thus, descriptions thereof will be omitted.

At least some of the components according to an exemplary embodiment of the present disclosure described so far may operate in conjunction with each other to implement an operation, controlling, or a control method of the electronic device 100 according to various embodiments described hereinafter. Also, an operation, controlling, or a control method of the electronic device 100 according to an embodiment of the present disclosure may be implemented in the electronic device 100 by driving at least one application program stored in the memory 117a.

The first wearing part 130a may be fastened to the first body 110a. The first wearing part 130a may be fastened to the first body 110a so as to be worn on the user's left ear. The second wearing part 130b may be fastened to the second body 110b. The second wearing part 130b may be fastened to the second body 110b so as to be worn on the user's right ear.

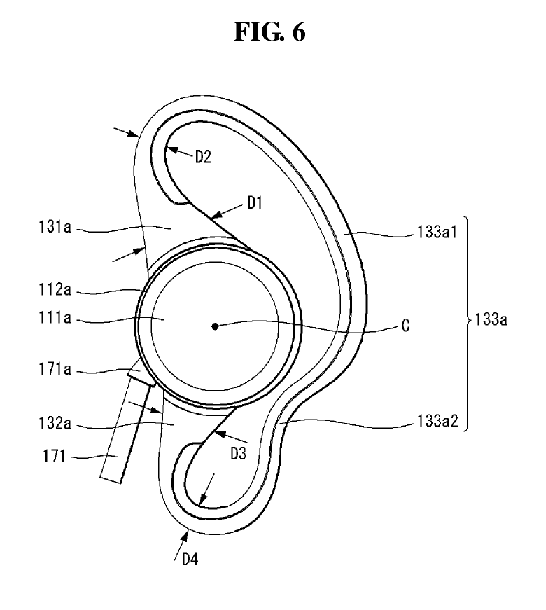

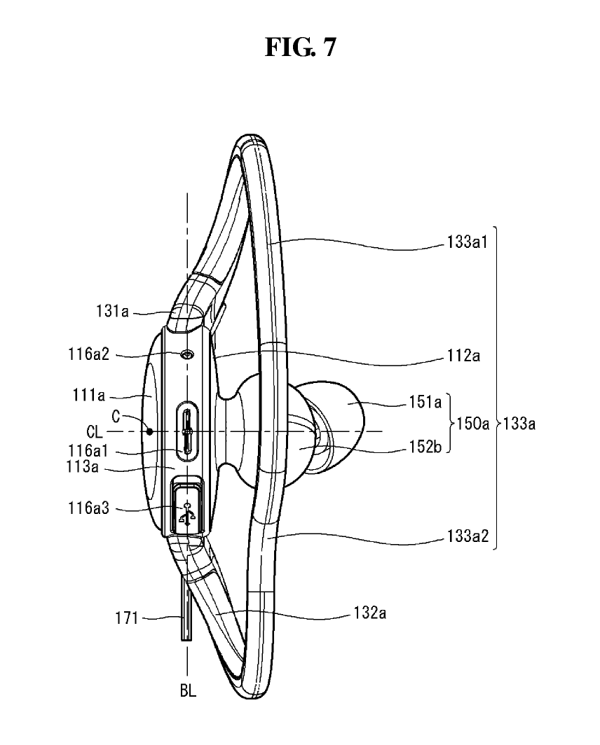

The first wearing part 130a and the second wearing part 130b may be differentiated as being left or right and fastened to the first body 110a and the second body 110b, respectively, but may substantially have the same shape and function. Thus, for the purposes of description, the first wearing part 130a will be representatively described with reference to FIGS. 6 and 7, without distinguishing between the first wearing part 130a and the second wearing part 130b.

Referring to FIGS. 6 and 7, the first wearing part 130a according to an embodiment of the present disclosure may include the first support 131a, the second support 132a, and the ear loop 133a. The first wearing part 130a may have a shape substantially similar to that of the user's ear in edges thereof.

One end of the first support 131a may be fastened to one side of the first body 110a and the other end thereof may be connected to the ear loop 133a. One end of the first support 131a may be disposed on the circumferential surface 113a of the body 110a and may be disposed at an upper end of the first body 110a. A width D1 of a portion of the first support 131a fastened to the first body 110a may be larger than a width D2 of a portion of the first support 131a connected to the ear loop 133a.

One end of the second support 132a may be fastened to the other side of the first body 110a and the other end thereof may be connected to the ear loop 133a. One end of the second support 132a may be disposed on the circumferential surface 113a of the first body 110a and disposed at a lower end of the body 110a. A width D3 of a portion of the second support 132a fastened to the body 110a may be larger than a width D4 of a portion of the second support 132a connected to the ear loop 133a.

Since the widths D1 and D3 of the first and second supports 131a and 132a are larger than the widths D2 and D4 of the first and second supports 131a and 132a, the first support 131a or the second support 132a rarely changes shape during operation, serving to support an overall shape of the first wearing part 130a.

The ear loop 133a may be connected to the first support 131a and the second support 132a and bent one or more times. One end of the ear loop 133a may be connected to the other end of the first support 131a and the other end thereof may be connected to the other end of the second support 132a. The ear loop 133a may have a shape substantially the same as that of the user's ear.

The ear loop 133a may include an ear-seated part 131a1 mounted while surrounding the user's earflap and an ear support 133a2 supporting a lower end of the user's earflap.

The ear-seated part 133a1 extends from the other end of the first support 131a and is bent to surround an inner side of an upper portion of the user's ear. The ear-seated part 133a1 may be convexly bent in a direction away from a central point C of the first body 110a to surround a helix and an inner side of cartilage of the user's ear. The central point C of the body 110a may be defined as a point which is the center of the first body 110a.

The ear-seated part 133a1 may be tilted toward the rear of the user's ear to easily surround the inner side of the upper portion of the user's ear. The ear-seated part 133a1 may be tilted to an inner side of the first body 110a on the basis of a reference line BL of the first body 110a. The reference line BL of the first body 110a may be defined as a line passing through a middle portion of the width of the circumferential surface 113a disposed between the upper surface 111a and the lower surface 112a of the first body 110a. The reference line BL may intersect with a central line CL extending from the central point C of the first body 110a in a first direction.

The ear-seated part 133a1 may be put on to surround an inner side of an upper portion of the user's ear, after passing the front of the helix of the user's ear, and thus, the ear-seated part 133a1 may be stably worn on the user's ear.

The ear support 133a2 may extend from the ear-seated part 133a1 and may be bent to support an inner side of a lower portion of the user's ear. The ear support 133a2 may be concavely bent toward the central point C of the first body 110a to support an inner side where the user's ear lobe and cartilage meet. The ear support 133a2 may be bent in more portions than the ear-seated part 133a1.

The ear support 133a2 may be disposed between the ear-seated part 133a1 and the second support 132a. The ear support 133a2 may extend from the ear-seated part 133a1 so as to be connected to the other side of the second support 132a.

The ear support 133a2 may be tilted toward the rear of the user's ear to more firmly support the inner side of the lower portion of the user's ear. The ear support 133a2 may be tilted toward the inner side of the first body 110a according to the reference line BL of the first body 110a. The ear support 133a2 may support the inner side of the lower portion of the user's ear, after passing a lower portion of the lobe of the user's ear, whereby the first wearing part 130a may be tightly attached to the user's ear and may not move arbitrarily in the user's ear. In addition, the first wearing part 130a includes both the ear-seated part 133a1 and the ear support part 133a2, arbitrary separation of the first wearing part 130a from the user's ear may be prevented in advance. The ear wearing parts 130a and 130b may stably be worn on the user's ear although the user does exercise such as walking, strolling, cycling, running, and the like, or plays intense sports such as extreme sports.

Also, the first body 110a may further include a power button 116a1 and an LED indicator 116a2. In the first body 110a, the power button 116a1 and the LED indicator 116a2 may be disposed in a region not overlapping the interface unit 116a, the first wearing part 130a, and the like, disposed on the circumferential surface of the first body 110a.

The power button 116a1 may turn on or off power of the electronic device 100. When the power button is clicked in a state in which the electronic device 100 is turned off, power of the electronic device 100 may be turned on. Conversely, when the power button is clicked in a state in which the electronic device 100 is turned on, power of the electronic device 100 may be turned off. When the electronic device 100 is turned off by an operation of the power button 116a1, information used by the user may be stored in the memory 117a under the control of the controller 118a before turning off is completed.

The LED indicator 116a2 may display a pairing state with a mobile terminal or another electronic device 100 or display a charge state. For example, when the electronic device 100 is normally paired with a mobile terminal or another electronic device 100, the LED indicator 116a2 may be displayed in green, and when the electronic device 100 is not paired, the LED indicator 116a2 may be displayed in red. Alternatively, when the LED indicator 116a2 is being charged through a charge terminal 116a3, the LED indicator 116a2 may be displayed in yellow. When charging is completed, the LED indicator 116a2 may be displayed in green. When charging is not normally performed, the LED indicator 116a2 may be displayed in red.

In FIGS. 3A, 3B, 6 and 7, for the purposes of description, the first wearing part 130a is described by separating the first support 131a, the second support 132a, and the ear loop 133a, but the first support 131a, the second support 132a, and the ear loop 133a may be formed to have one shape, without being separated.

Referring to FIGS. 1, 8 and 9, the first ear housing 150a may be fastened to the inner surface 112a of the first body 110a. The first ear housing 150a may be fastened to the first body 110a so as to be worn on the user's left ear. The second ear housing 150b may be fastened to the inner surface 112b of the second body 110b. The second ear housing 150b may be fastened to the second body 110b so as to be worn on the user's right ear.

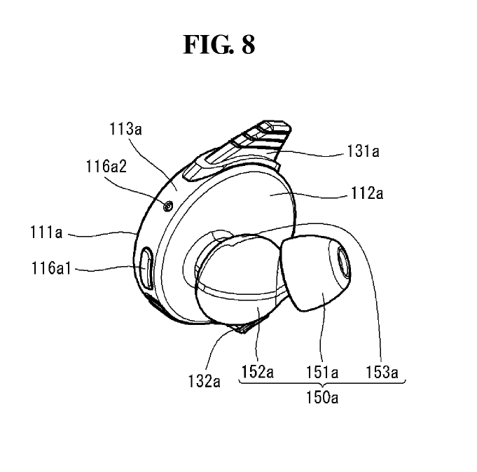

The first ear housing 150a and the second ear housing 150b may be distinguished as being left or right so as to be fastened to the first body 110a and the second body 110b, respectively, but may have substantially the same shape and function. Thus, in FIGS. 8 and 9, for the purposes of description, the first ear housing 150a will be representatively described, without distinguishing between the first ear housing 150a and the second ear housing 150b.

The first ear housing 150a may include first and second housings 152a and 153a, an ear cap 151a, a nozzle 154a, a speaker 155a, and a fastening member 160.

The first ear housing 150a may include a first housing 152a and a second housing 153a. The nozzle 154a may be disposed on one side of an upper end surface of the first housing 152a. A lower end of the first housing 152a may be fastened to an upper end of the second housing 153a. A lower end surface of the second housing 153a may be fastened to the inner surface 112a of the body 110a. The first ear housing 150a may be hollow and a speaker 155a, a fastening member 160, and the like, may be disposed therein.

Also, the first housing 152a may have a radius that increases from an upper end toward a lower end thereof. That is, the ear housings 150a and 150b may have a pot shape in which an inlet and a bottom surface thereof are narrow. The shape of the ear housings 150a and 150b may be defined as a bottleneck shape so as to be easily caught by an antitragus of the user's ear.

The ear cap 151a may come into contact with the user's ear. The ear cap 151a may be fastened to the nozzle 154a as described hereinafter and inserted into a canal of the user's ear. The ear cap 151a may be deformed to have a shape similar to that of the canal of the user's ear so as to be tightly attached to the canal of the user's ear. While the user is wearing the electronic device 100, the ear cap 151a may appropriately press the canal of the user's ear to block an external sound. The ear cap 151a may have elasticity so as to be deformed while being tightly attached to the canal of the user's ear and returned to the original state when it is separated from the canal of the user's ear.

The nozzle 154 may protrude from an upper end surface of the first housing 152a so as to be inserted into the canal of the user's ear. The nozzle 154a may be disposed to be lopsided on the upper end surface of the first housing 152a such that the electronic device 100 worn on the user's ear may be tightly attached to the user's ear. The nozzle 154a may transmit a sound output through the speaker 155a to the user's ear.

The speaker 155a may be disposed within the first ear housing 150a and may be disposed between the first housing 152a and the second housing 153a. The speaker 155a may be disposed on an upper end surface of the second housing 153a. The speaker 155a may be electrically connected to the controller 118a disposed within the bodies 110a and 110b. The speaker 155a may convert an electrical signal supplied from the controller 118a into sound output.

In addition, when the speaker 155a is disposed on the upper end surface of the second housing 153a, a rear space of the speaker 155a may become an echo space. The echo space may affect sound quality. The echo space may be varied depending on a position and an angle of the speaker 155a disposed on the upper end surface of the second housing 153a. Thus, the echo space may be varied according to a change in angle between the speaker 155a and the nozzle 154a. Details thereof will be described in more detail below.

The fastening member 160 may be fastened to the first body 110a through a lower end surface of the second housing 153a. The fastening member 160 may include a bolt, a screw, and the like, converting a rotational motion into a linear motion. Here, the fastening member 160 is illustrated as a bolt or a screw, but is not limited thereto. Any component may be used as the fastening member 160, as long as it can fasten the second housing 153a to the bodies 110a and 110b.

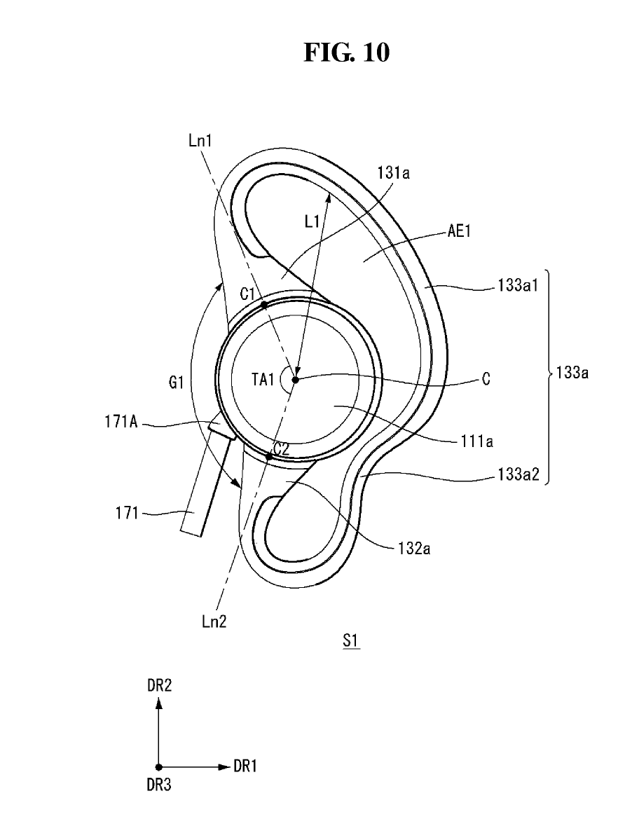

Referring to FIG. 10, in the electronic device 100 according to an embodiment of the present disclosure, the first support 131a and the second support 132a of the first wearing part 130a may be in a first state S1. A first direction DR is an X direction as a transverse direction, a second direction DR2 is a Y direction perpendicular to the first direction DR1, and a third direction is a Z direction perpendicular to each of the first direction DR1 and the second direction DR2.

The first state S1 may be defined as a state in which the first support 131a and the second support 132a are maintained at a first gap G1. Alternatively, the first state S1 may be defined as a state corresponding to a first tilting angle TA between a first line Ln1 formed by linking the central point C1 of the first body 110a and a central point C1 at one end of the first support 131a and a second line Ln2 formed by linking the central point C of the first body 110a and a central point C2 at one end of the second support 132a.

When the electronic device 100 is viewed in the third direction DR3, a predetermined area between an outer edge of the first body 110a and an inner edge of the first wearing part 130a may be visible in the electronic device 100. The predetermined area may be a first area AE1 in the first state S1. Here, in the electronic device 100, a distance L1 from the central point C of the first body 110a to the ear-seated part 133a1 may be substantially equal to or longer than the user's cartilage.

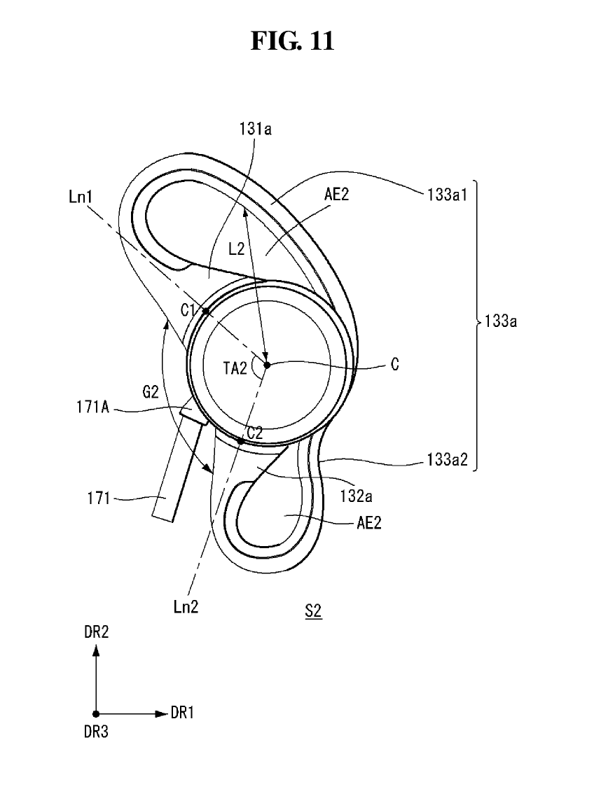

Referring to FIG. 11, in the electronic device 100 according to an embodiment of the present disclosure, the first support 131a and the second support 132a of the first wearing part 130a may be in a second state S2. The second state S2 may be defined as a state in which the first support 131a and the second support 132a are maintained at a second gap G2. Alternatively, the second state S2 may be defined as a state corresponding to a second tilting angle TA2 between a first line Ln1 formed by linking the central point C1 of the first body 110a and a central point C1 at one end of the first support 131a and a second line Ln2 formed by linking the central point C of the first body 110a and a central point C2 at one end of the second support 132a. The second gap G2 is different from the first gap G1. The second gap G2 may be shorter than the first gap G1. The second tilting angle TA1 is different from the first tilting angle TA1. The second tilting angle may be smaller than the first tilting angle.

When the electronic device 100 is viewed in the third direction DR3, a second area AE2 between the outer edge of the first body 110a and the inner edge of the first wearing part 130a may be visible in the electronic device 100. The predetermined area may be a first area AE1 in the first state S1. Here, in the electronic device 100, a distance L2 from the central point C of the first body 110a to the ear-seated part 133a1 may be shorter than the user's cartilage. The second area AE2 may be smaller than the first area AE1.

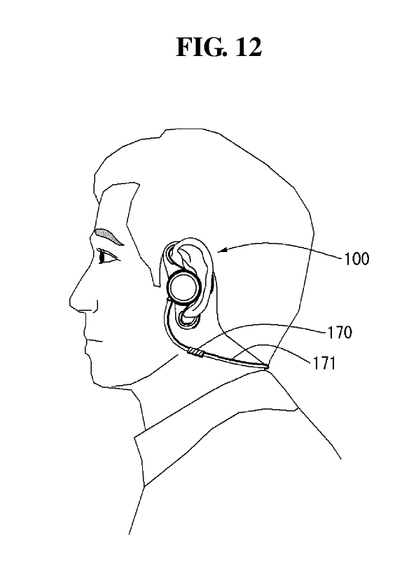

Referring to FIG. 12, in the electronic device 100, the first support 131a may be rotated at the predetermined tilting angles TA and TA2 with respect to the central point C of the first body 110a. Here, the second support 132a may be fastened to be fixed to the first body 110a. The second support 132a may support the overall shape of the electronic device 100, while the first support 131a is rotated. When the first support 131a is rotated to maintain the first tilting angle TA1 with the second support 132a, the electronic device 100 may be in the first state S1, and when the first support 131a is rotated to maintain the second tilting angle with the second support 132a, the electronic device 100 may be in the second state S2.

The electronic device 100 may be worn on the user's ear in the first state S1. Since the electronic device 100 has the first area AE1 larger than the second area AE2 in the first state S1, the electronic device 100 may be easily put on the user's ear.

After being put on the user's ear, the electronic device 100 may be switched from the first state S1 to the second state S2 by rotating the first support 131a. The user may easily rotate the first support 131a with his index finger or middle finger. Since the electronic device 100 has the second area AE2 smaller than the first area AE1 in the second state S2, the electronic device 100 may not be easily released or otherwise removed from the user's ear.

In addition, when the electronic device 100 is in the second state S2, the ear-seated part 133a1 may be mounted on the inner side of the user's cartilage and the ear support 133a2 may support the inner side of a lower end of the user's ear. Accordingly, the electronic device 100 may be tightly attached or otherwise coupled to the user's ear and may not be arbitrarily moved.

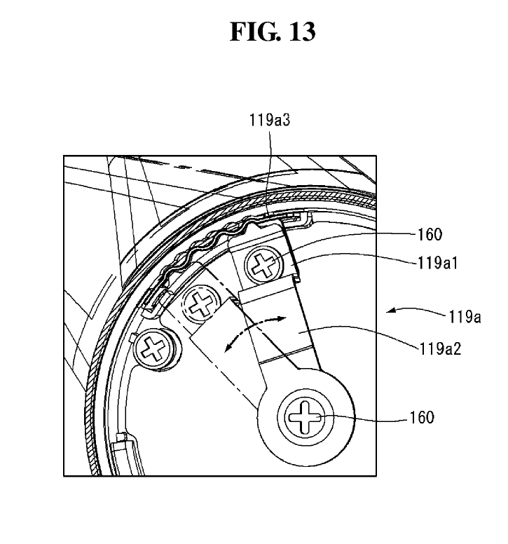

Referring to FIG. 13, the tilting unit 119a may include a damper member 119a1, a damper controller 119a2, and a damper-seated part 119a3.

The tilting unit 119a may be disposed within the first body 110a and may be disposed in a position corresponding to the first support 131a.

The damper member 119a1 may include an elastic material. For example, the damper member 119a1 may include a leaf spring.

One end of the damper controller 119a2 may be fastened to the first body 110a and the other end thereof maybe fastened to an upper end surface of the damper member 119a1.

The damper controller 119a2 may be fastened to the damper member 119a1 by the fastening member 160.

The damper-seated part 119a3 may be provided within the first body 110a to correspond to a region in which the first support 131a is rotated. The damper-seated part 119a3 may have a wavy pattern. For example, the damper-seated part 119a3 may have a shape in which ridges and valleys are repeated.

The damper-seated part 119a3 may be formed of a material different from that of the first body 110a and may be formed of a polyacetal material having a smaller relative coefficient of wear/friction as compared to that of the first body 110a.

The damper member 119a1 may be positioned in a first valley of the plurality of patterns of the damper-seated part 119a3. The user may apply force to the first support 131a in a clockwise direction. When the force applied to the first support 131a exceeds elastic force of the damper member 119a1 and the damper controller 119a2, the damper member 119a1 may be deformed. Thus, the damper member 119a1 may be moved to a second valley of the plurality of patterns of the damper-seated part 119a3. Through this operation, the damper member 119a1 may be moved to a final valley of the plurality of patterns of the damper-seated part 119a3. As the damper member 119a1 is moved from the first valley to the final valley, the first support 131a may be rotated to be switched from the first state S1 to the second state S2.

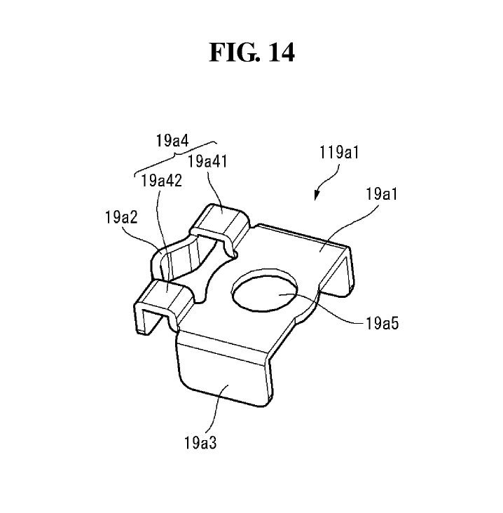

Referring to FIG. 14, the damper member 119a1 may include a body 19a1, a body support member 19a3, an elastic member 19a2, and a buffer member 19a4.

The body 19a1 has a quadrangular shape and has a fastening hole 19a1 disposed in a central region thereof. The fastening hole 19a5 may be disposed to penetrate through the body 19a1. The fastening member 160 may penetrate through the fastening hole 19a5 to fasten the damper member 119a and the damper controller 119a2.

The body support member 19a3 may be disposed at each of an upper end and a lower end of the body 19a1 and extend in a direction which is the same as a direction in which the fastening hole 19a5 penetrates through the body 19a1.

The elastic member 19a2 may be spaced apart from the body 19a1 at a predetermined interval. The elastic member 19a2 may be bent convexly in a direction away from the body 19a1.

The buffer member 19a4 may be disposed on a left end side of the body 19a1 and extend to be connected to the elastic member 19a2. The buffer member 19a4 may include a first buffer member 19a41 and a second buffer member 19a42. The first buffer member 19a41 may extend to be connected to one side of an upper end surface of the elastic member 19a2. The second buffer member 19a42 may be spaced apart from the first buffer member 19a41 and extend to be connected to the other side of the upper end surface of the elastic member 19a2.

The elastic member 19a2 of the damper member 119a1 may contact the damper-seated part 119a3 and serve as a stopper. That is, the first support 131a may be rotated and fixed to a position in which the elastic member 19a2 is in contact with the damper-seated part 119a3.

The tilting unit 119a configured as described above may smoothly perform damping, while the first support 131a makes a rotational motion.

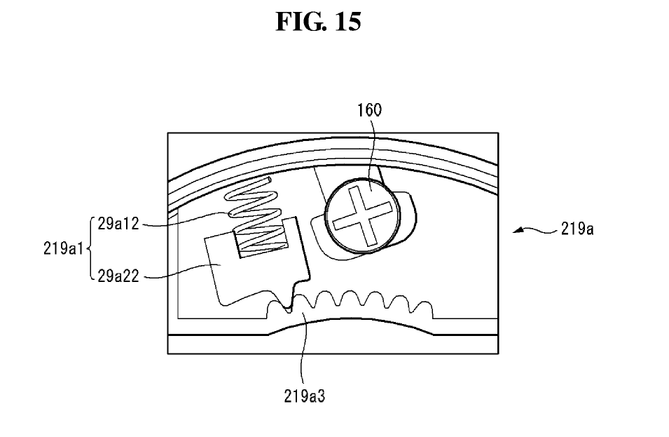

Referring to FIG. 15, a tilting unit 219a according to another embodiment of the present disclosure may include a damper member 219a1 and a damper-seated part 219a3.

The tilting part 219a may be disposed within the first body 110a and may be disposed in a position corresponding to the first support 131a.

The damper member 219a1 may include a cover member 29a22 and an elastic member 29a 12. A portion of an upper end surface of the cover member 29a22 may protrude. One end of the elastic member 29a12 may be inserted and fastened to a lower end surface of the cover member 29a22, and the other end thereof may be fastened to the inside of the first body 110a.

The elastic member 29a12 may include an elastic material. For example, the elastic member 29a12 may include an elastic spring. Alternatively, the cover member 29a22 may include a rigid material without elasticity.

The damper-seated part 219a3 may be formed within the first body 110a to correspond to a region in which the first support 131a makes a rotational motion. The damper-seated part 219a3 may have a wavy pattern. For example, the damper-seated part 219a3 may have a shape in which ridges and valleys are repeated.

The damper-seated part 219a3 may be formed of a material different from that of the first body and may be formed of a polyacetal material having a relatively smaller coefficient of wear/friction.

The damper member 219a1 may be positioned in a first valley of the plurality of patterns of the damper-seated part 219a3. The user may apply force to the first support 131a in a clockwise direction. When the force applied to the first support 131a exceeds elastic force of the damper member 219a1 and the damper controller 219a2, the damper member 219a1 may be deformed. Thus, the damper member 219a1 may be moved to a second valley of the plurality of patterns of the damper-seated part 219a3. Through this operation, the damper member 219a1 may be moved to a final valley of the plurality of patterns of the damper-seated part 219a3. As the damper member 219a1 is moved from the first valley to the final valley, the first support 131a may be rotated to be switched from the first state S1 to the second state S2.

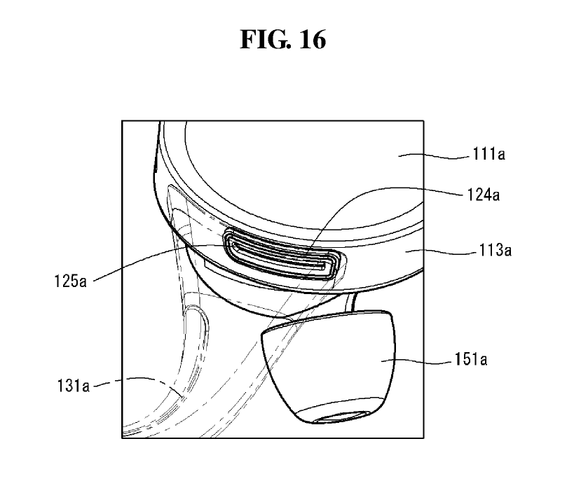

Referring to FIG. 16, in the first body 110a, a first support recess 125a, into which one end of the first support 131a is inserted, may be disposed on an upper side of the circumferential surface 113a. Although not shown in FIG. 16, a second support recess, into which one end of the second support 132a is inserted, may be disposed on a lower side of the circumferential surface 113a.

A waterproof member 124a may be disposed between the first support 131a and the first body 110a. The waterproof member 124a may be disposed on one surface of the first support recess 125a such that the first support recess 125a may not be exposed outwardly.

The waterproof member 124a may include a material preventing or inhibiting moisture or foreign material from permeating inwardly. For example, the waterproof member 124a may include silicon, rubber, and the like, having high water repellency.

Since the waterproof member 124a having high water repellency is disposed on one surface of the first support recess 125a, an introduction of moisture or a foreign material to the first body 110a through the support recess, while the first support 131a is being rotated to the first state S1 or the second state S2, may be prevented.

The waterproof member 124a may have at least one protrusion extending from an upper surface in contact with one end surface of the first support 131a. Here, the protrusion may be rib shaped. Since the waterproof member 124a has the protrusion on the upper surface thereof, moisture or a foreign material permeating through between the first support 131a and the first body 110 may be more easily blocked. In addition, since a contact area of the first support 131a with respect to the first body 110a is reduced by the protrusion of the waterproof member 124a, the first support 131a may be easily rotated to the first state S1 or the second state S2.

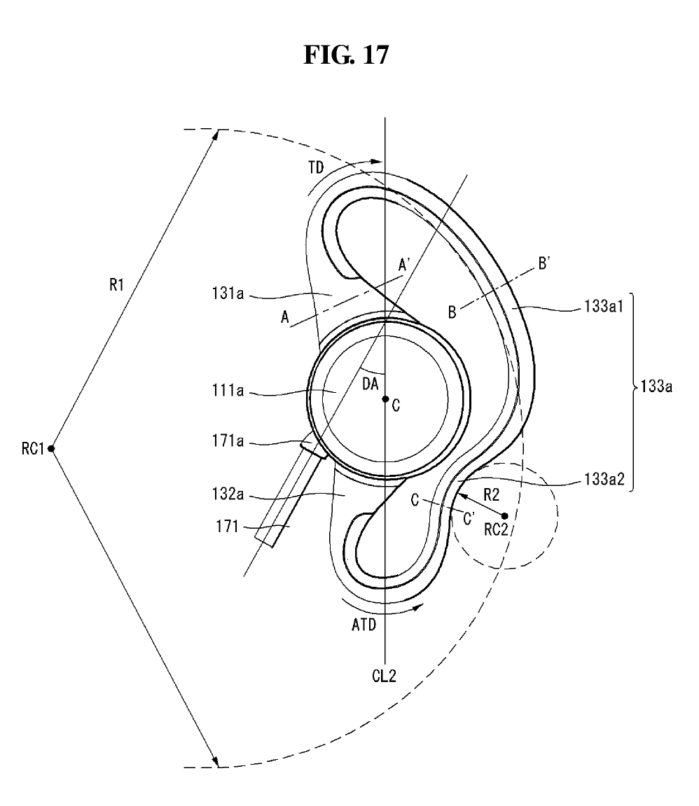

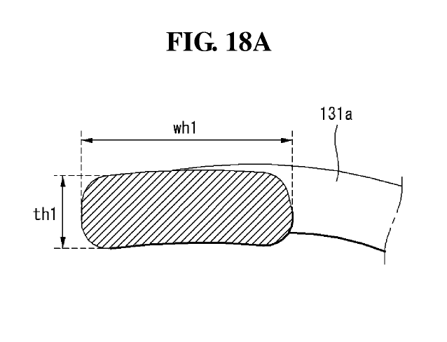

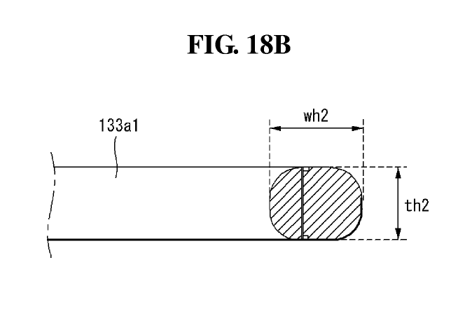

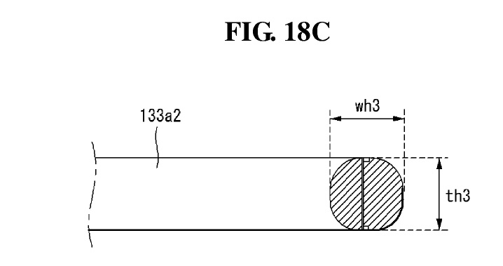

Referring to FIGS. 17 and 18, the electronic device 100 according to an embodiment of the present disclosure may include the first support 131a, the second support 132a, and the ear loop 133a.

One end of each of the first and second supports 131a and 132a may be fastened to the first body 110a. One end of each of the first and second supports 131a and 132a may be increased in width wh1 toward the first body 110a, and may be rounded along the circumferential surface 113a of the first body 110a. Thus, the first and second supports 131a and 132a may be stably fastened to the first body 110a. The other end of the first support 131a may be bent at a predetermined angle in a clockwise direction TD. The other end of the second support 132a may be bent at a predetermined angle in a counterclockwise direction ATD.

The ear loop 133a may include an ear-seated part 133a1 and an ear support 133a2. One end of the ear-seated part 133a1 may be connected to the other end of the first support 131a, and the other end thereof may be connected to one end of the ear support 133a2. One end of the ear support 133a2 may be connected to the other end of the ear-seated part 133a1 and the other end thereof may be connected to the other end of the second support 132a.

The ear-seated part 133a1 may be rounded with a first radius of curvature R1 to surround the user's ear. A central point RC1 of the first radius of curvature R1 may be disposed to be spaced apart to be away from the ear-seated part 133a1 in a direction toward the first body 110a.

The ear support 113a2 may be bent with a second radius of curvature R2 to support an inner side of the user's ear. A central point RC2 of the second radius of curvature R2 may be disposed to be spaced part to be close from the first body 110a in a direction toward the ear support 133a2.

The first radius of curvature RC1 may be greater than the second radius of curvature RC2. Thus, the ear-seated part 133a1 may be bent more gently than the ear support 133a2.

Also, in the first body 110a, the first molding member 171a, from which the cable 171 may be drawn out, may be disposed between the first support 131a and the second support 132a. The first molding member 171a may guide a drawn-out angle of the cable 171 from the first body 110a. The drawn-out angle DA of the cable 171 may be defined as an angle at a point where a second central line CL2 passing through the central point C of the first body 110a in a vertical direction and the cable 171 drawn out and extending from the first molding member 171a intersect with each other.

The drawn-out angle DA of the cable 171 may range from 25° to 35°. If the drawn-out angle DA is less than 25°, the cable 171 may interfered with the first wearing part 130a. If the drawn-out angle DA is greater than 35°, a fixing structure disposed within the first body 110a to fix the first molding member 171a may be increased in size.

The first molding member 171a may be bent such that the cable 171 may be naturally drawn out toward a lower end of the first body 110a. Also, the cable 171 may include a thermoplastic elastomer (TPE) material. The cable 171 including the TPE material may be drawn out through the first molding member 171a and naturally oriented downward.

FIG. 18A is a cross-sectional view of one end of the first and second supports 131a and 132a, taken along line A-A′ of FIG. 17. The first and second supports 131a and 132a may have a first width wh1 and a first thickness th1. FIG. 18B is a cross-sectional view of the ear-seated part 133a1, taken along line B-B′ of FIG. 17. The ear-seated part 133a1 may have a second width wh2 and a second thickness th2. FIG. 18C is a cross-sectional view of the ear support 133a2, taken along line C-C′. The ear support 133a2 may have a third width wh3 and a third thickness th3.

The first width wh1 may be larger than the second width wh2 and the third width wh3. The first width wh1 may be larger by 2-5 times than the second width wh2 and the third width wh3. The first thickness th1 may be greater than the second thickness th2 and the third thickness th3. In this manner, since the first width wh1 and the first thickness th1 of the first and second supports 131a and 132a are larger and greater than the widths wh2 and wh3 and the thicknesses th2 and th3 of the ear loop 133a, the first and second supports 131a and 132a are rarely changed in shape, while the first support 131a is being rotated, supporting the overall shape of the wearing parts 130a and 130b.

The second width wh2 may be smaller than the first width wh1 and larger than the third width wh3. The second thickness th2 may be smaller than the first thickness th1 and substantially equal to the third thickness th3. In this manner, since the second width of the ear-seated part 133a1 is larger than the width wh3 of the ear support part 133a2 and smaller than the width wh1 of the first and second supports 131a and 132a, an overall shape of the ear-seated part 133a1 may be easily changed, while the first support 131a is being rotated. That is, the ear-seated part 133a1 may be changed in overall shape according to tilting angles of the first support 131a so as to fit to surround the user's ear, while the first support 131a is being rotated.

If the second width wh2 is equal to or larger than the first width wh1, it may be difficult to change an overall shape of the ear-seated part 133a1, while the first support 131a is being rotated. That is, since the other end of the first support 131a is connected to the ear-seated part 133a1, a greater amount of force may be required for the rotation as the second width wh2 of the ear-seated-part 133a1 increases. In addition, a changed reaction speed of the ear-seated part 133a1 may also slow by the increased portion of the second width wh2.

The third width wh3 may be smaller than the first width wh1 and the second width wh2. The third thickness th3 may be smaller than the first thickness th1 and may be substantially equal to the second thickness th2. The ear support 133a2 may be connected to the second support 132a fastened and fixed to the bodies 110a and 110b so that an overall shape of the ear support 133a2 may rarely be changed. Thus, although the ear support 133a2 has a width smaller than that of the ear-seated part 133a1, the ear support 133a2 may support the inner side of the user's ear.

Also, the ear support 133a2 may be disposed in a position lower than the ear-seated part 133a1. That is, the ear-seated part 133a1 may be seated at an upper end of the user's cartilage, while the ear support 133a2 may be disposed to support a lower end of the user's cartilage. Thus, if the ear support 133a2 has the same width wh2 as that of the ear-seated part 133a1, a relatively larger load may be applied to the user. Thus, preferably, the ear support 133a2 has a width smaller than that of the ear-seated part 133a1 in order to reduce an overall weight of the ear loop 133a, while firmly supporting the inner side of the user's ear.

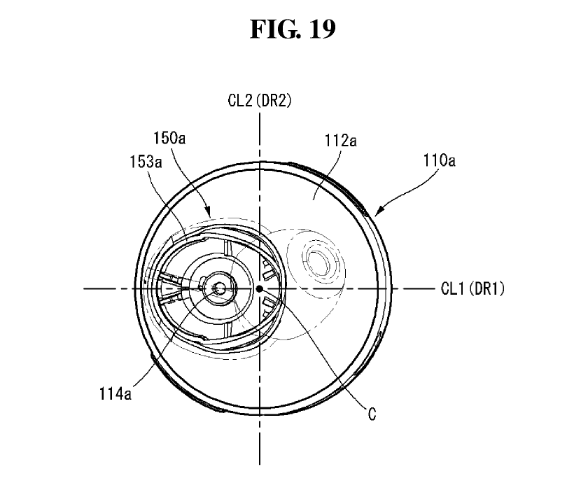

Referring to FIG. 19, the first housing 153a of first ear housing 150a may be fastened to the inner surface 112a of the first body 110a.

The first body 110a may include a first central line CL1 passing through the central point C of the first body 110a (FIG. 6) in a first direction DR1 and a second central line CL2 passing through the central point of the bodies 110a and 110b in a second direction DR2 perpendicular to the first direction DR1.

The first ear housing 150a may be fastened to deviate from the central point C of the first body 110a in the inner surface 112a of the first body 110a. The first ear housing 150a may deviate from the central point C of the first body 110a and may be disposed on the first central line CL1. The first ear housing 150a may be disposed on the left with respect to the second central line CL2. Thus, the first ear housing 150a may be disposed to have a hook structure in the first body 110a. Here, it is illustrated that the first ear housing 150a is disposed on the first central line CL1, but the present disclosure is not limited thereto and the first ear housing 150a may be disposed to be adjacent to the first central line CL1.

Also, as described above with reference to FIG. 8, the first ear housing 150a may have a pot shape in which an inlet and a bottom surface are narrow. That is, the shape of the first ear housing 150a may be a bottleneck shape so as to be easily caught by the antitragus of the user's ear.

Since the first ear housing 150a has a bottleneck shape and is fastened to deviate from the central point C of the first body 110a, the first ear housing 150a may be accurately caught by the antitragus of user's ears. Thus, when the user wears the electronic device 100, the ear cap 151a of the first ear housing 150a may be easily inserted into the canal of the user's ear and the first ear housing 150a may be accurately put on the antitragus. Also, when the user removes the electronic device 100, the first ear housing 150a may be naturally released from the canal and the antitragus of the user's ear.

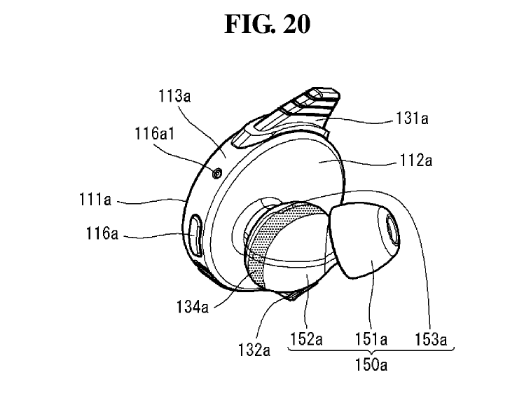

Referring to FIG. 20, the first ear housing 150a may have a patterned part 134a surrounding a central region of the ear housing 150a and having a predetermined width. The patterned part 134a may surround a lower end of the first housing 152a and an upper end of the second housing 153a by a predetermined width. The patterned part 134a may have at least one protrusion protruding with a predetermined height. The patterned part 134a may be disposed in a portion which comes into contact with the user's skin when the first ear housing 150a is caught by the antitragus. Since the first ear housing 150a has the pattern part 134a in a portion which comes into contact with the user's skin, an area directly in contact with the user's skin may be minimized. In this manner, since the contact area of the first ear housing 150a which comes directly into contact with the user's skin is reduced, the ear canal may be appropriately pressed and wearing sensation may be improved. Thus, the user may wear the electronic device 100 for a long period of time.

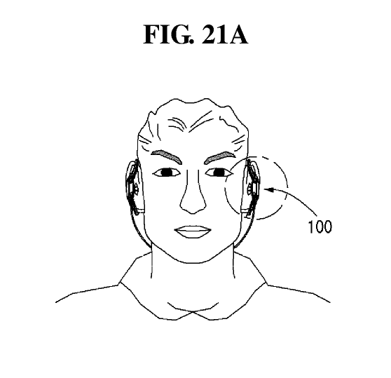

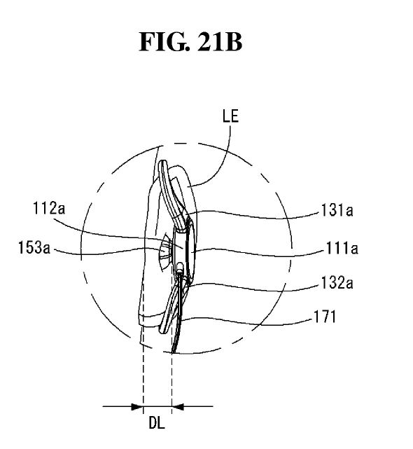

FIG. 21 is a front view illustrating a state in which the user wears the electronic device 100.

When the electronic device 100 is worn on the user's ears, a portion of the first wearing part 130a and a portion of the first ear housing 150a of the electronic device 100 are in contact with the user's skin. The first body 110a of the electronic device 100 may be spaced apart from the user's skin by a predetermined interval DL, without being in contact with the user's skin. In the first body 110a, since the first ear housing 150a disposed on the inner surface 112a has a bottleneck shape, the first body 110a may be spaced apart from the user's skin by the predetermined interval DL, rather than being directly in contact with the user's skin.

Also, in the electronic device 100, while the first ear housing 150a is seated on the user's ears, the first wearing part 130a may be rotated from the first state S1 (FIG. 10) to the second state S2 (FIG. 11). As the first wearing part 130a is rotated from the first state S1 to the second state S2, the first support 131a may be tilted to a front side of the user. Thus, the electronic device 100 may be further easily tightly attached to the user's ears.

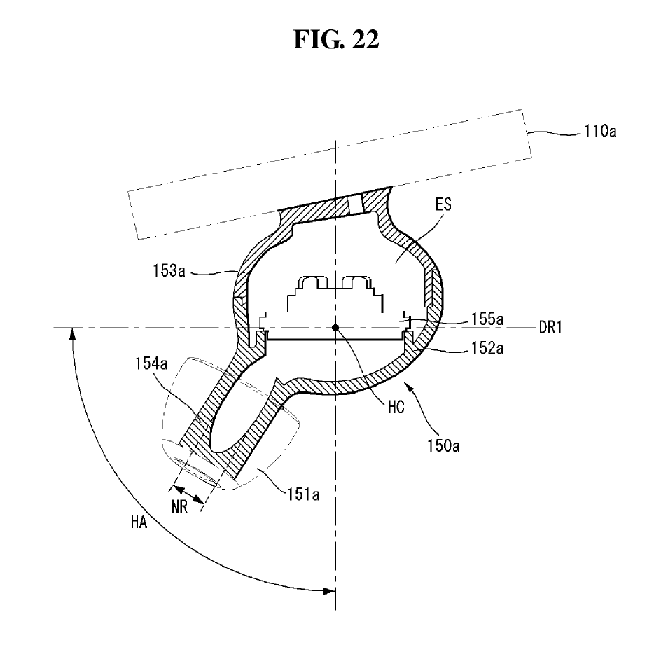

FIG. 22 is a cross-sectional view of the first ear housing 150a, taken in the second direction.

The first ear housing 150a may include the first and second housings 152a and 153a, the ear cap 151a, the nozzle 154a, the speaker 155a, and the fastening member 160. The first ear housing 150a may be fastened to the inner surface 112a of the first body 110a. The first ear housing 150a may be fastened to the first body 110a so as to be put on the user's left ear.

The first housing 152a may have the nozzle 154a disposed on one side of an upper end surface thereof. A lower end of the first housing 152a may be fastened to an upper end of the second housing 153a. A lower end surface of the second housing 153a may be fastened to the inner surface 112a of the first body 110a. The first ear housing 150a may be hollow so the speaker 155a, the fastening member 160, and the like, may be disposed therein.

The speaker 155a, the ear cap 151a, the nozzle 154a, and the fastening member 160 have been described above sufficiently, and thus, descriptions thereof will be omitted.

The speaker 155a may be disposed between a lower end of the first housing 152a and an upper end of the second housing 153a. In the second housing 153a, the speaker 155a may be disposed at the upper end of the second housing 153a and the inside of the second housing 153a below the speaker 155a may be hollow. That is, in the second housing 153a, an echo space ES may be provided below the speaker 155a. The echo space ES may be provided on the rear side of the speaker 155a and affect sound quality output from the speaker 155a.

Also, the echo space ES may be varied according to positions, angles, and the like, of the speaker 155a disposed at the upper end of the second housing 153a. The echo space ES may be varied according to a change in a horizontal angle HA. Here, the horizontal angle HA may be defined as an angle at which the nozzle 154a is tilted with respect to a central point HC of the speaker 155a in the first direction as a transverse direction. In the first ear housing 150a, the horizontal angle HA between the nozzle 154a and the speaker 155a is set to range from 15° to 25° to move to a band in which a frequency value F0 is low. Here, the frequency value F0 represents a lowest resonance frequency and may indicate a low band frequency limit value of the speaker. Thus, in the electronic device 100, by setting the horizontal angle HA between the nozzle 154a and the speaker 155a to range from 15° to 25°, a degradation of low band characteristics may be improved.

Also, after the speaker 155a of the first ear housing 150a is set in the transverse direction, it may move to a higher frequency band of F0 as a radius NR of the nozzle 154a is increased. That is, as the diameter NR of the nozzle 154a of the electronic device 100 is increased, a register characteristics value may be increased.

In this manner, the electronic device 100 may be designed to have an optimal value of low band characteristics in consideration of the relationship between the horizontal angle HA between the nozzle 154a and the speaker 155a and the diameter NR of the nozzle 154a.

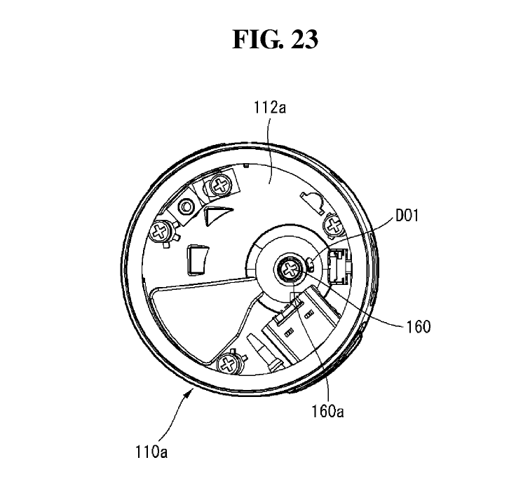

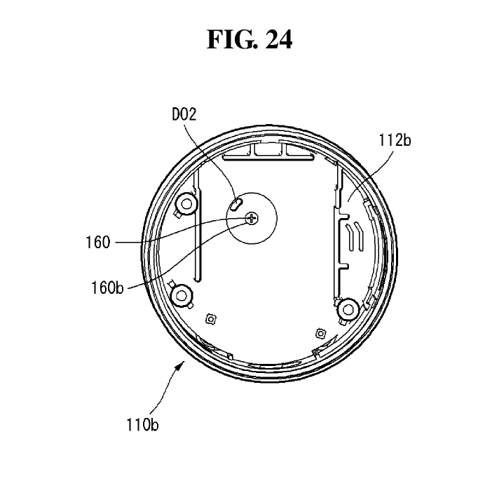

Referring to FIGS. 23 and 24, since the wireless communication unit 115a, the controller 118a, and the like, are disposed in the first body 110a (FIG. 3B) and the power supply unit 121b is disposed in the second body 110b (FIG. 5B), the internal structures of these components are different.

On the inner surface 112a of the first body 110a, a fastening recess 160a is provided, into which the fastening member 160 fastening the second housing 153a and the first body 110a may be inserted and a first drawn-out recess DO1 from which a signal line electrically connected to the speaker 155a is drawn out from the first body 110a.

On the inner surface 112b of the second body 110b, a fastening recess 160b is provided, into which the fastening member 160 fastening the second housing 153a and the first body 110b may be inserted and a second drawn-out recess DO02 from which a signal line electrically connected to the speaker 155a is drawn out from the second body 110b.

In FIG. 23, the first drawn-out recess DO1 may be disposed on the lower end surface in a corresponding position in consideration of the internal structure of the first body 110a, and in FIG. 24 the second drawn-out recess DO02 may be disposed on the lower end surface in a corresponding position in consideration of the internal structure of the second body 110b. The first and second drawn-out recesses DO1 and D02 are preferably disposed in portions not affected by the internal structure of the first and second bodies 110a and 110b.

Also, in the first and second bodies 110a and 110b, in order to maintain predetermined sound pressure in the echo space ES, a wire is drawn out and the first and second drawn-out recesses DO1 and D02 may be sealed to prevent leakage of sound pressure. Here, in each of the first body 110a and the second body 110b, a sealing point sealed to the first drawn-out recess DO1 and a sealing point sealed to the second drawn-out recess D02 may differ. In this manner, by differentiating the sealing points in the first and second bodies 110a and 110b, the echo space ES formed in the second housing 153a of the first body 110a and the echo space ES formed in the second housing 153a of the second body 110b may be secured in the same manner. Thus, the first and second bodies 110a and 110b may realize the same or similar sound quality.

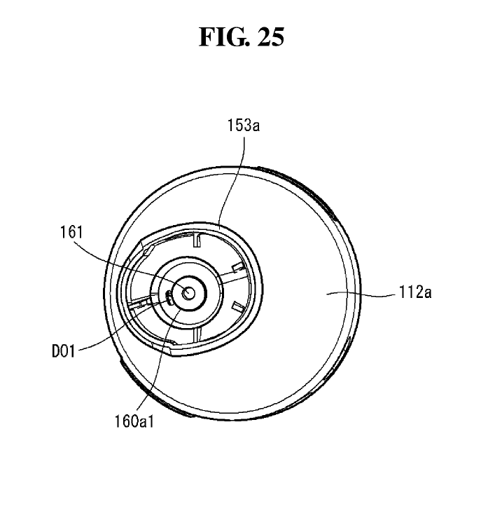

The first body 110a may have a fastening recess 160a fastened to the fastening member 160 on a lower surface thereof. In FIG. 25, in the second housing 153a, a fastening recess 160a1 of the second housing 153a may be disposed in a position corresponding to the fastening recess 160a of the first ear housing 150a. Thus, the fastening member 160 may also be fastened to the fastening recess 160a1 of the second housing 153a.

A fixing member 161 preventing idle running of the fastening member 160 when the fastening member 160 is fastened may be disposed at an upper end of the fastening recess 160a1 of the second housing 153a. The fastening member 160 may sequentially penetrate through the fastening recess 160a of the first body 110a and the fastening recess 160a1 of the second housing 153a so as to be fastened, and finally, fastened to the fixing member 161. Since the fastening member 160 is fastened to the fixing member 161, idle running of the fastening member 160 or arbitrary release of the fastening member 160 from the fastening recess 160a1 of the second housing 153a may be prevented. Thus, the first ear housing 150a may be firmly fixed to the first body 110a by the fastening member 160 and the fixing member 161.

Also, since the first ear housing 150a is fastened to the first body 110a by the fastening member 160, the first ear housing 150a may be easily separated. That is, when the first ear housing 150a or the first body 110a requires replacement or inspection, the first ear housing 150a or the first body 110a may be separated and only the faulty element may be repaired or replaced.

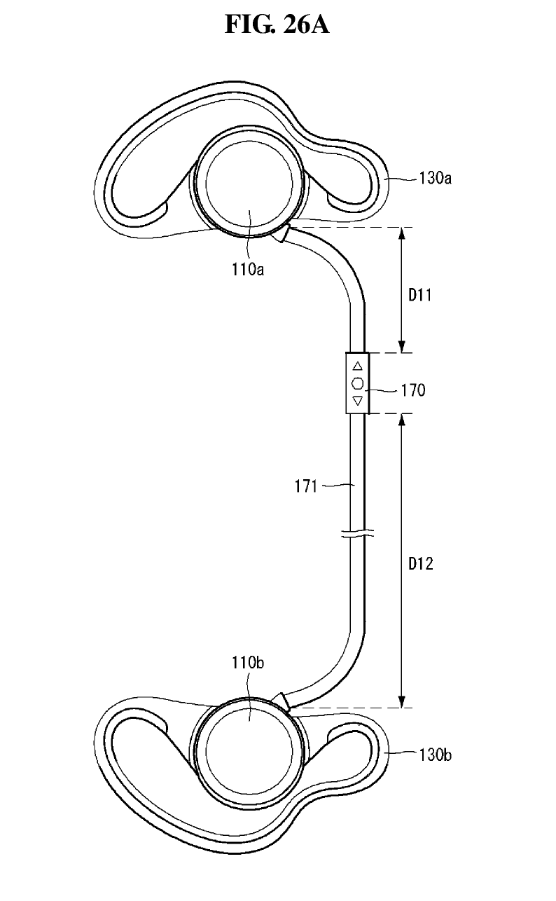

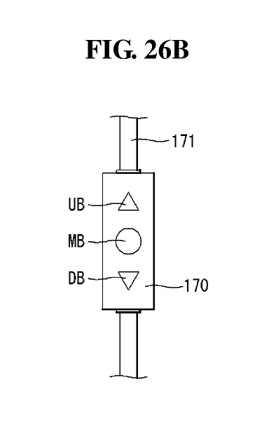

Referring to FIGS. 26A, 26B, the first body 110a may be electrically connected to the second body 110b through the cable 171. The cable 171 may include at least one line, such as a signal line, a power line, and the like.

The cable 171 may include the remote controller button part 170 for controlling the electronic device 100. The remote controller button part 170 may have at least one button UB, MB, and DB. The at least one button UB, MB, and DB may include a first button UB to a third button DB.

The first button UB may be disposed at an upper end of the remote controller button part 170, and the third button DB may be disposed at a lower end of the remote controller button part 170. The second button MB may be disposed between the first button UB and the third button DB.

The first button UB may raise the volume or select a next piece of music. For example, the volume may be raised one level each time the first button UB is clicked once. Alternatively, when the first button UB is quickly double-clicked, a currently played piece of music may be switched to a next piece of music.

The second button MB may play music or stop playing music, and may answer a call or hang up the phone. For example, when a call is received, the user may click the second button MB to answer the call, and may hang up the phone by clicking the second button MB again. Alternatively, in cases where the user wants to enjoy music, the user may play music by clicking the second button MB and stop playing the music by clicking the second button MB again. Also, when the second button MB is long-clicked, the electronic device 100 may be turned on or off.

The third button DB may lower the volume or select a previous piece of music. For example, the volume may be lowered one level each time the third button DB is clicked. Alternatively, when the third button DB is quickly double-clicked, a currently played piece of music may be switched to a previously piece of music.

The remote controller button part 170 may be disposed between the first body 110a and the second body 110b, and may be disposed to be closer to the first body 110a. A first distance D11 between the remote controller button part 170 and the first body 110a may be smaller than a second distance D12 between the remote controller button part 170 and the second body 110b.

The remote controller button part 170 may be electrically connected to the controller 118a disposed in the first body 110a. Thus, as the first distance D11 between the remote controller button part 170 and the controller 118a is shorter, a length of a signal line electrically connecting the remote controller button part 170 and the controller 118a may be reduced. As a signal line for exchanging signals is shorter, less noise occurs. Thus, the remote controller button part 170 may exchange more accurate signals with the controller 118a.

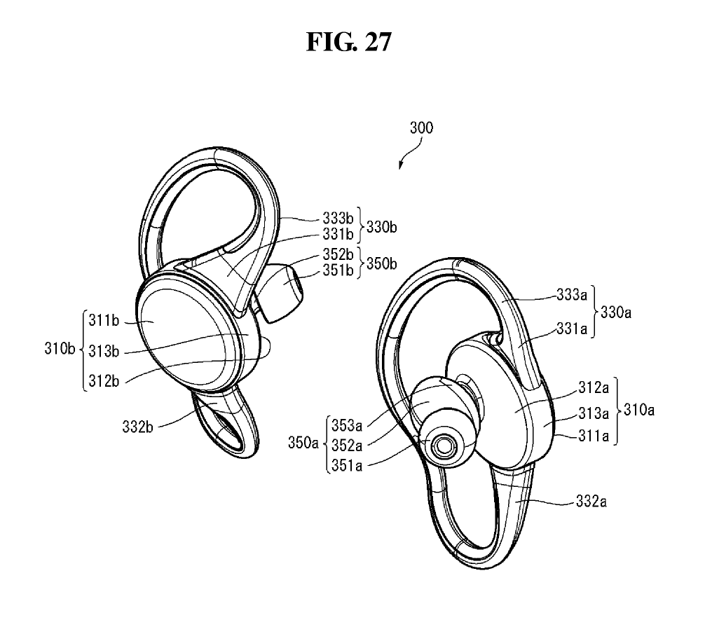

Referring to FIG. 27, in an electronic device 300 according to another embodiment of the present disclosure, first and second bodies 310a and 310b may be wirelessly connected. The first body 310a may wirelessly receive data from the second body 310b and/or the second body 310b may wirelessly receive data from the first body 310a.

Although not shown, the first body 310a and the second body 310b may each include a power supply unit and a wireless communication unit. The power supply unit and the wireless communication unit have substantially the same components and functions as those of the power supply unit 121b (FIGS. 4, 5A, 5B) and the wireless communication unit 115a (FIGS. 2, 3A, 3B) described above, and thus, descriptions thereof will be omitted.

Also, components of wearing parts 330a and 330b and ear housing 350a and 350b are substantially the same as those of the wearing parts 130a and 130b and the ear housings 150a and 150b described above with reference to FIGS. 1, 2, 3A, 3B, 4, 5A, 5B, and thus, descriptions thereof will be omitted.

The first body 310a and the second body 310b are wirelessly connected to each other, and may be set as a master and a slave. When the first body 310a is set as a master, the second body 310b may be a slave, and when the second body 310b is set as a master, the first body 310a may be slave.

The electronic device 300 may set a body 310a or 310b in which a controller (not shown) and a memory (not shown) are disposed, among the first body 310a and the second body 310b, as a master. When the master is set, the other body 310a or 310b may be set as a slave.

Also, the electronic device 300 may set a body 310a or 310b in which a battery (not shown) having high capacity is disposed, among the first body 310a and the second body 310b, as a master. When the master is set, the other body 310a or 310b may be set as a slave. Thus, the electronic device 300 may first charge the first body 310a as a master under the control of the controller, and after the first body 310a is charged, the electronic device 300 may be controlled to charge the second body 310b.

In this manner, the electronic device 300 configured in a wireless manner may be paired with a user's mobile terminal through the first body 310a as a master. Pairing with the mobile terminal will be described later.

Also, although not shown, the electronic device 300 may include a notification member in the first body 310a and the second body 310b. The notification member may not operate when the first body 310a and the second body 310b are positioned within a set reference range. When the first body 310a or the second body 310b are not within the set reference range, the notification member may output a notification sound so that the user may recognize that the first body 310a and the second body 310b are separated.

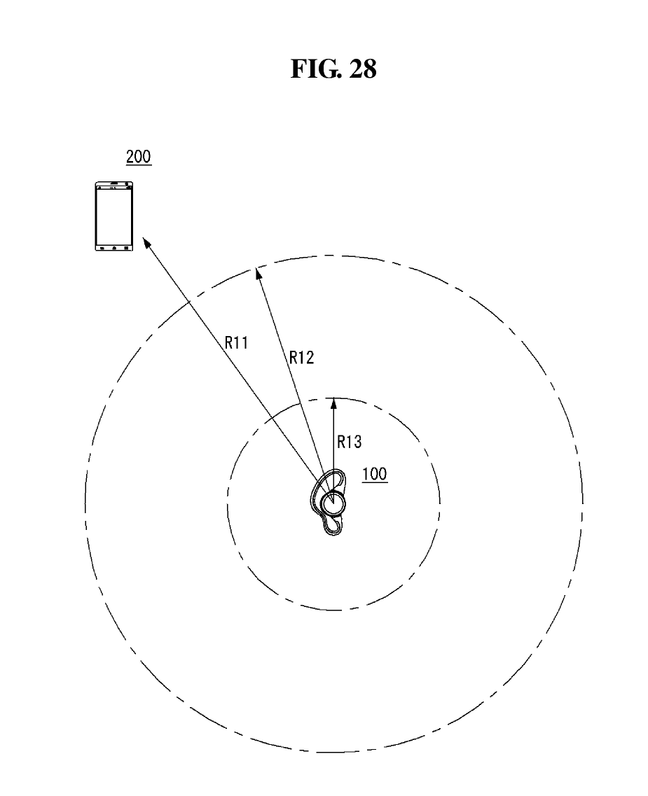

As illustrated in FIG. 28, the electronic device 100 may be in a predetermined relationship with a mobile terminal 200. That is, the electronic device 100 may be in a state of being paired with the mobile terminal 200.

The electronic device 100 may be within a predetermined distance from the mobile terminal 200. The predetermined distance may include first to third distances R11 to R13. The electronic device 100 may perform different operations according to distances to the mobile terminal 200. When the electronic device 100 is at the first distance R11, the electronic device 100 may be turned off, when the electronic device 100 is at the second distance R12, the electronic device 100 may be turned on. When the electronic device 100 is at the third distance R13, the electronic device 100 may provide information about an accurate location. For example, the electronic device 100 may inform the user about an accurate location of the electronic device 100 through vibration at a predetermined interval, sound at a predetermined interval, and/or display at a predetermined interval.

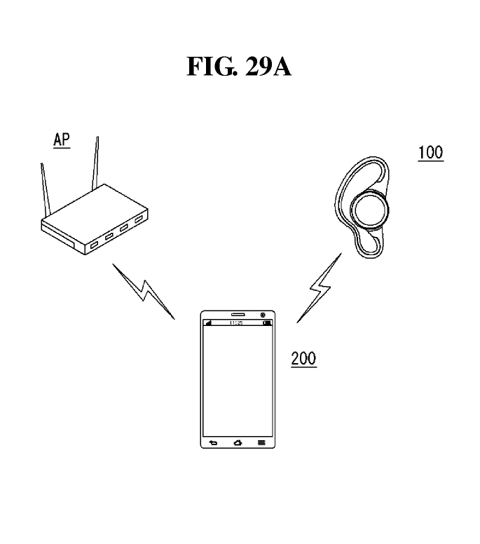

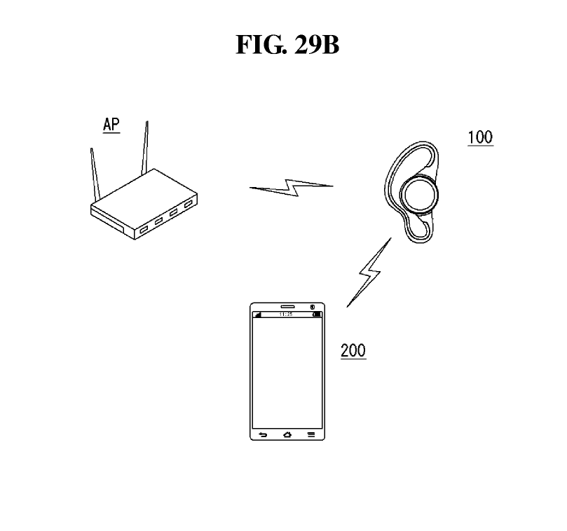

As illustrated in FIGS. 29A, 29B, and 30-32, the electronic device 100 according to another embodiment of the present disclosure may perform a predetermined operation with the mobile terminal 200 of the user. The electronic device 100 may form a single system with the mobile terminal 200 and one of the electronic device 100 and the mobile terminal 200 may transmit a control signal to the other.

As illustrated in FIG. 29A, the electronic device 100 may receive external data through the mobile terminal 200. The mobile terminal 200 may communicate with a base station (or an access point (AP)). The electronic device 100 may receive external data from the mobile terminal 200 through Bluetooth communication, or the like. That is, the mobile terminal 200 may process data received from an external device such as the AP and transmit the processed data to the electronic device 100.

As illustrated in in FIG. 29B, the electronic device 100 may directly communicate with an external device. The electronic device 100 may receive data directly from the AP. The electronic device 100 may obtain data from the AP and transmit the data to the mobile terminal 200 using pairing.

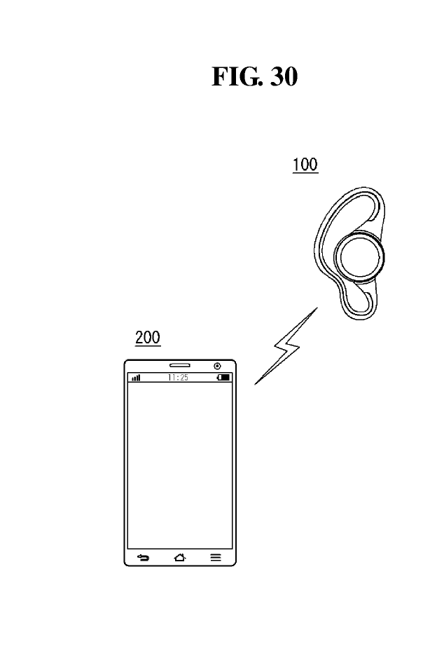

As illustrated in FIG. 30, the electronic device 100 may interwork with the mobile terminal 200 of the user. Here, interworking may refer to a state in which the electronic device 100 and the mobile terminal 200 exchange data.

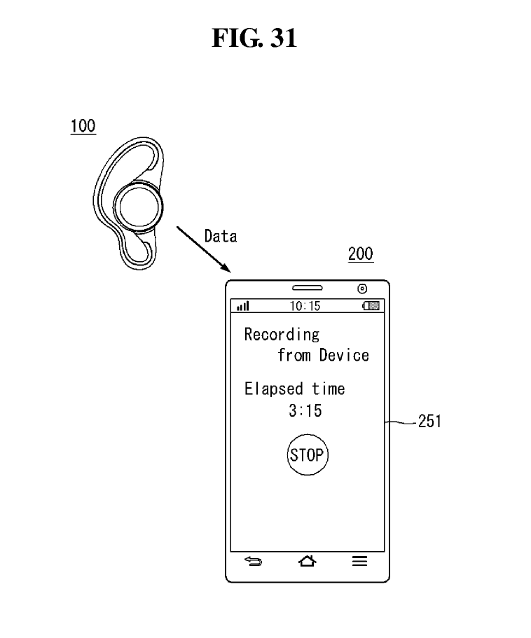

As illustrated in FIG. 31, the electronic device 100 may transmit data to the mobile terminal 200. For example, the user may perform a recording function using the electronic device 100. The electronic device 100 may have a memory having a least capacity required for an operation of the electronic device 100 or may have a memory with a small remaining capacity. The electronic device 100 may transmit recorded data to the mobile terminal 200. The mobile terminal 200 may store the recorded data transmitted from the electronic device 100. The mobile terminal 200 may display a storing situation of the recorded data received from the electronic device 100.

The electronic device 100 may transmit various types of data. The electronic device 100 may transmit biometric signal data of a user obtained through a heart rate sensor, or the like, movement data obtained through an accelerometer, or the like, to the mobile terminal 200. The electronic device 100 may have low data processing capability, relative to the mobile terminal 200. Thus, the electronic device 100 may transmit raw data to the mobile terminal, and the mobile terminal 200 may process the received raw data and inform the user accordingly.

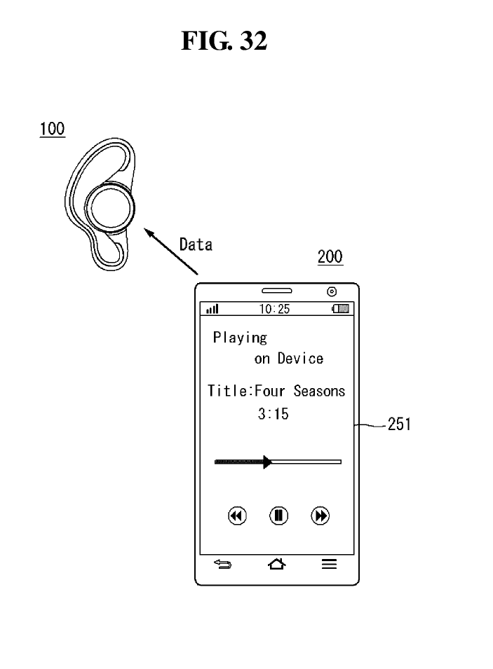

As illustrated in FIG. 32, the mobile terminal 200 may transmit data to the electronic device 100. The electronic device 100 may transmit sound data using a connected Bluetooth communication channel. Although the electronic device 100 does not retain a large amount of content therein, the electronic device 100 may obtain content required for reproduction from another device such as the mobile terminal 200 and output the obtained content.

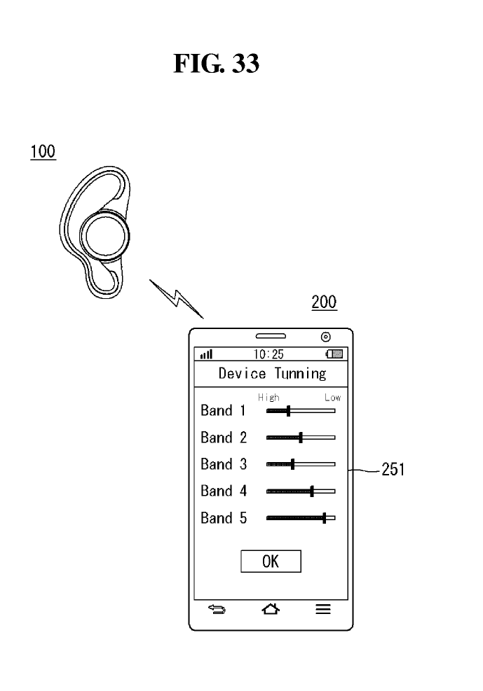

As illustrated in FIG. 33, the electronic device 100 may be controlled by the mobile terminal 200. The user may tune a speaker of the electronic device 100 using the mobile terminal 200.

The electronic device 100 may not have a display or may have a display too small to display sufficient information. The user may conveniently control the electronic device 100 using the mobile terminal 200 retaining a relatively large display 251.

The present invention described above may be implemented as a computer-readable code in a medium in which a program is recorded. The computer-readable medium includes any type of recording device in which data that can be read by a computer system is stored. The computer-readable medium may be, for example, a hard disk drive (HDD), a solid state disk (SSD), a silicon disk drive (SDD), a ROM, a RAM, a CD-ROM, a magnetic tape, a floppy disk, an optical data storage device, and the like. The computer-readable medium also includes implementations in the form of carrier waves (e.g., transmission via the Internet). Also, the computer may include a controller of a terminal.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An electronic device comprising:
a body; and
a first support coupled to one portion of the body, wherein the first support extends from the body along a line in a first direction relative to a central axis of the body;
a second support coupled to another portion of the body, wherein the second support extends from the body along a line in a second direction relative to the central axis of the body; and
an ear loop connecting the first support to the second support, wherein a shape of the ear loop permits coupling with a user's ear, wherein the shape of the ear loop changes according to changes in a degree of an angle between the line in the first direction and the line in the second direction.

2. The electronic device of claim 1, wherein the first support and the second support are offset relative to a side of the body to permit coupling of the ear loop to an inner side of cartilage of the user's ear.

3. The electronic device of claim 2, wherein the ear loop includes:
an ear-seated part extending from the first support and being bent to border an upper end of the inner side of the cartilage; and
an ear support extending from the ear-seated part and being bent to border a lower end of the inner side of the cartilage.

4. The electronic device of claim 3, wherein the ear-seated part is concave relative to the body and the ear support is convex relative to the body.

5. The electronic device of claim 1, further comprising:
an ear housing sized to be inserted into the user's ear and is coupled to an inner side of the body.

6. The electronic device of claim 5, wherein a portion of the ear housing has a central axis that deviates from the central axis of the body.

7. The electronic device of claim 6, wherein the ear housing includes:
a first housing having an upper end and a lower end;
a second housing having an upper end and a lower end, wherein the upper end of the second housing is coupled to the lower end of the first housing and the lower end of the second housing is coupled to the inner side of the body;
a nozzle protruding from one side of the upper end of the first housing; and
a speaker located within the first housing and the second housing,
wherein the second housing forms an echo space within an internal space between the speaker and a surface of the inner side of the body.

8. The electronic device of claim 1, wherein the body comprises:
a tilting unit located at an upper end of a circumferential surface of the body, wherein the tilting unit is coupled to one end of the first support,
wherein the tilting unit includes:
a damper-seated part corresponding to a region in which the first support is rotated, wherein the damper-seated part includes ridges and valleys along an inside of the body;
a damper member located to make contact with the damper-seated part, and being deformed in shape when brought into contact with the ridges, and returned to an original shape when brought into contact with the valleys; and
a damper controller having one end fastened to the body and another end coupled to the damper member and rotating in a same direction as that of the first support.

9. The electronic device of claim 1, wherein the body comprises:
a tilting unit located at an upper end of a circumferential surface of the body, wherein the tilting unit is coupled to one end of the first support,
wherein the tilting unit includes:
a damper-seated part corresponding to a region in which the first support is rotated, wherein the damper-seated part includes ridges and valleys along an inside of the body; and
a damper member located to make contact with the damper-seated part, and being contracted in length when brought into contact with the ridges, and returned to an original length when brought into contact with the valleys.

10. The electronic device of claim 1, further comprising:
a waterproof member located between the first support and the body.

11. The electronic device of claim 1, wherein the body includes:
a molding member located between the first support and the second support and is shaped to allow cable to be drawn out therethrough, and wherein a drawn-out angle of the cable ranges from 25° to 35° with regard to a vertical direction.

12. The electronic device of claim 1, further comprising:
an ear housing sized to be inserted into the user's ear and is coupled to an inner side of the body, wherein the ear housing includes a patterned part surrounding a central region of the ear housing.
